(19) United States
(12) Patent Application Publication
(10) Pub. No.: US 2026/0282076 A1
(43) Pub. Date: Sep. 17, 2026

(54) OPERATING COMMUNICATION NETWORKS

(71) Applicant: FRAUNHOFER-GESELLSCHAFT ZUR FÖRDERUNG DER ANGEWANDTEN FORSCHUNG E.V., München (DE)

(72) Inventors: Thomas HAUSTEIN, Berlin (DE); Paul Simon Holt LEATHER, Berlin (DE)

(21) Appl. No.: 19/672,360

(22) Filed: May 8, 2026

Related U.S. Application Data
(63) Continuation of application No. PCT/EP2024/081766, filed on Nov. 8, 2024.

(30) Foreign Application Priority Data
Nov. 10, 2023 (EP) 23209203.1

(51) Int. Cl. H04W 74/04; H04W 52/02

(52) U.S. Cl. CPC H04W 74/04; H04W 52/0216

(57) ABSTRACT

A device comprises a wireless interface configured for processing a wireless signal. The device is to schedule the processing of the wireless signal to the occurrence of a communication opportunity being known in advance.

### CROSS-REFERENCE TO RELATED APPLICATIONS

This application is a continuation of copending International Application No. PCT/EP2024/081766, filed Nov. 8, 2024, which is incorporated herein by reference in its entirety, and additionally claims priority from European Application No. EP 23209203.1, filed Nov. 10, 2023, which is also incorporated herein by reference in its entirety.

The present invention relates to the field of wireless communication systems or networks, more specifically a use of at least one Artificial Intelligence/Machine Learning model, AI/ML, model or at least one AI/ML functionality for performing one or more tasks. Embodiments of the present invention concern enhancements of AI/ML reporting, AI/ML monitoring, AI/ML pre-processing, AI/ML management and AI/ML inference.

### BACKGROUND OF THE INVENTION

FIG. 1 is a schematic representation of an example of a terrestrial wireless network 100 including, as is shown in FIG. 1A, the core network, CN, 102 and one or more radio access networks RAN₁, RAN₂, . . . . RAN_{N}. FIG. 1B is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards, e.g., a base station in a 6G network. The BS may also comprise of integrated access and backhaul, IAB, nodes, e.g., an IAB Donor and/or IAB Node, consisting of a central unit, CU, as well as of a distributed unit, DU, and/or containing IAB-MTs including IAB mobile termination, MT. The term base station may refer to an access point, AP, in any of the WiFi standards, e.g., belonging to the IEEE 802.11-family. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANₙ may include more or less such cells, and RANₙ may also include only one base station. FIG. 1B shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1B shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1B by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 1B by the arrows pointing to “gNBs”. A sidelink channel allows direct communication between UEs, also referred to as device-to-device, D2D, communication. The sidelink interface in 3GPP is named PC5. Note, that the term user equipment, UE, or user device may also refer to a station, STA, as used in any of the WiFi standards, e.g., belonging to the IEEE 802.11-family.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st}-stage SCI, and optionally, a second control region which contains a second part of control information, also referred to as the 2^{nd}-stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with 3GPPs LTE, LTE-Advanced, LTE-Advanced Pro, or the 5G or 5G-Advanced or 6G or 3GPPs NR, New Radio, or within LTE-U, LTE Unlicensed or NR-U, New Radio Unlicensed, which is specified within the LTE and within NR specifications.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro or 5G or 5G-Advanced or NR, New Radio, or a possible future 6G radio system.

In mobile communication networks, for example in a network like that described above with reference to FIG. 1, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are necessarily outside one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations or a WiFi AP.

It is noted that the information in the above section is only for enhancing the understanding of the background of the invention and, therefore, it may contain information that does not form conventional technology that is already known to a person of ordinary skill in the art.

Starting from the above, there may be a need for improvements or enhancements of operating wireless communication networks and devices adapted for wireless communication.

### SUMMARY

According to an embodiment, a device may have: a wireless interface configured for processing a wireless signal; wherein the device is to schedule the processing of the wireless signal to the occurrence of a communication opportunity being known in advance

### BRIEF DESCRIPTION OF THE DRAWINGS

Embodiments of the present invention will be detailed subsequently referring to the appended drawings, in which:

FIG. 1A-B illustrate a wireless communication network, wherein FIG. 1A is a schematic representation of an example of a terrestrial wireless network, and FIG. 1B is a schematic representation of an example of a radio access network, RAN;

FIG. 2 is a schematic representation of a wireless communication system including a transmitter, like a base station, and one or more receivers, like user devices, UEs, implementing embodiments of the present invention;

FIG. 3 shows a schematic block diagram of a device according to an embodiment of the first aspect;

FIG. 4 shows a schematic block diagram of a wireless communication scenario according to an embodiment of the first aspect;

FIG. 5 shows a schematic block diagram of actions to be done for transmitting a signal according to the first aspect;

FIG. 6 shows a schematic block diagram of a wireless communication scenario according to an embodiment of the second aspect;

FIG. 7 shows a condition of wireless communication scenario having two direct connections established, according to an embodiment of the second aspect;

FIG. 8 shows a schematic illustration of a situation of a wireless communication scenario where four direct links are established according to an embodiment of the second aspect;

FIG. 9 shows a schematic illustration of a situation of a wireless communication scenario where a UE uses another UEs to achieve a connection to a NWE;

FIG. 10 shows a schematic illustration of a situation of a wireless communication scenario where two direct connections have been established, according to an embodiment of the second aspect;

FIG. 11 shows a schematic illustration of a situation of a wireless communication scenario where multiple direction connections have been established, according to an embodiment of the second aspect;

FIG. 12 shows a schematic illustration of a scenario of a group of devices in a scenario where some UEs are within coverage of their respective network entities, according to an embodiment of the second aspect;

FIG. 13 shows a schematic top view of a geographical area where different coverage areas are located, according to an embodiment of the second aspect;

FIG. 14 shows an example illustration of known communication characteristics in different networks;

FIG. 15 shows an example illustration of main packet processing in known programmable forwarding devices;

FIG. 16 shows different schematic block diagrams of network topologies in connection with embodiments of the third aspect;

FIG. 17 shows a schematic block diagram of a data packet according to an embodiment of the third aspect;

FIG. 18 shows a schematic block diagram for illustrating a possible structure of a header block according to an embodiment of the third aspect;

FIG. 19 shows an example of an arrangement of addresses within an address block according to an embodiment of the third aspect;

FIG. 20 shows a schematic block diagram of an example structure of an extension block, according to an embodiment of the third aspect;

FIG. 21 shows a schematic block diagram of a reserved block according to an embodiment of the third aspect;

FIG. 22 shows a schematic block diagram of a block arrangement of a message comprising a modified extensions block labeled as raw extensions in block according to an embodiment of the third aspect;

FIG. 23 shows an example of a datagram or message packet comprised of various blocks including refined extensions according to an embodiment of the third aspect;

FIG. 24 shows a schematic block diagram of a wireless communication network to illustrate an end-to-end packet delivery of a message according to an embodiment of the third aspect;

FIG. 25 shows a schematic block diagram of a wireless communication network to illustrate an non-end-to-end packet delivery of a message according to an embodiment of the third aspect; and

FIG. 26 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

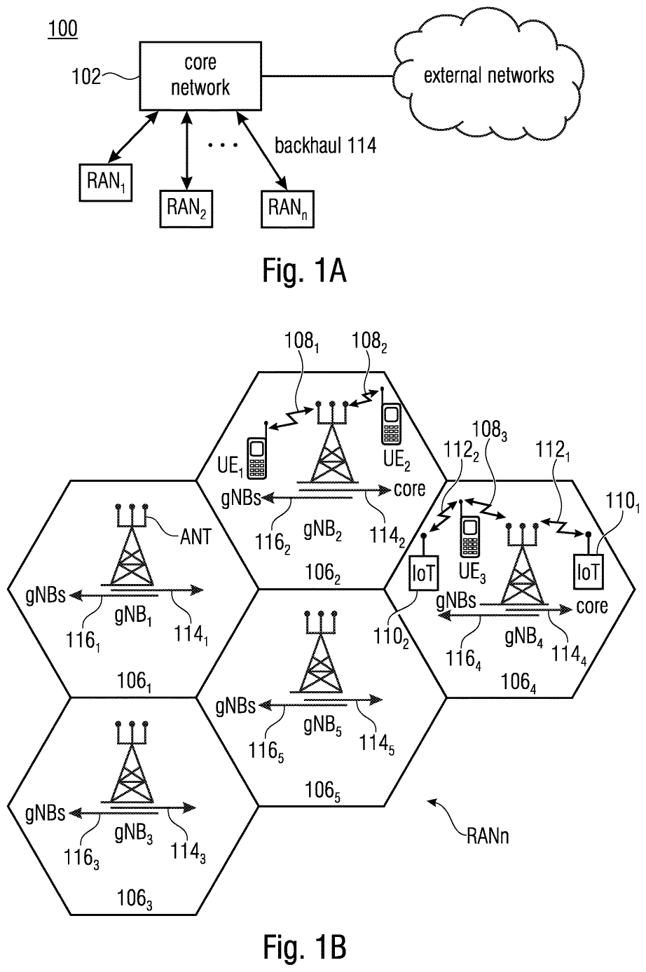

In conventional wireless communication networks or systems, like the one described above with reference to FIG. 1, which may be a current 5G NR systems, a large overhead is caused by characterizing the radio channel and exchanging an estimate of the radio channel between user equipment, UE, and the base station, gNB. The overhead may be caused by a gNB transmitting training symbols in the NR downlink, by triggering measurement reports at the UE, as well as procedures for transmitting training signals from the UE to a gNB in the NR uplink. Furthermore, the overall system performance may depend on various factors, e.g., other UEs within the vicinity, the position and speed of a UE, the interference caused by neighboring cells, etc. 5G-Advanced and 6G systems may overcome some of the drawbacks mentioned here by utilizing AI/ML algorithms and by adapting procedures and protocols accordingly, and thus improve overall system performance of 5G NR telecommunication systems.

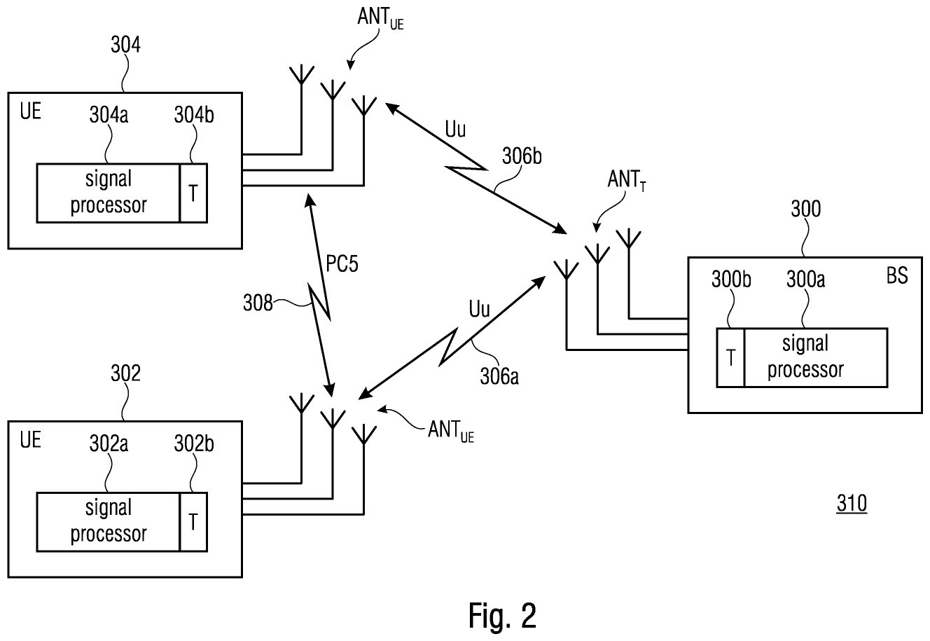

Embodiments of the present invention may be implemented in a wireless communication system as depicted in FIG. 1 including base stations and users, like mobile terminals or IoT devices. FIG. 2 is a schematic representation of a wireless communication system 310 including a transmitter 300, like a base station, and one or more receivers 302, 304, like user devices, UEs. The transmitter 300 and the receivers 302, 304 may communicate via one or more wireless communication links or channels 306a, 306b, 308, like a radio link.

The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 2, the one or more UEs 302, 304 of FIG. 2, and the base station 300 of FIG. 2 may operate in accordance with the inventive teachings described herein.

### Aspect 1

According to a first aspect, embodiments relate to message preparation in situations when a device is said to be out of coverage, OOC, e.g., with regard to distress messages. The inventors have identified a problem in known systems as follows.

Wireless communication can save lives and de-escalate emergency situations by providing emergency connectivity through which requests for help, assistance, advice and the such like can be made. Today's communication networks and, in particular cellular networks, are omni-present in many countries, especially in urban and dense urban environments. On the other hand, in regions of rugged terrain, rural areas, off-shore maritime zones or sparsely-populated locales, cellular coverage might not be available or at best might only offer patchy coverage accompanied by poor service levels especially when compared to the deployment of enhanced mobile broadband (eMBB) in urban areas.

When traveling in areas of poor or partial coverage, some users might perceive this as an inconvenience or frustration. However, when an emergency or a situation close to an emergency occurs, the ability to send even the simplest message can make a difference as to when rescue arrives, if indeed it arrives at all.

The current invention addresses the problem of the preparation and transmission of emergency distress messages or distress calls and the associated communication responses.

The inventors address in particular the case of temporal communication opportunities that are offered, for example, by low earth-orbit (LEO) communication satellites. Here, an a priori knowledge about communication opportunities and the timely preparation of emergency messages is needed to ensure that the transmission opportunity is used effectively, especially when such a window of communication might only last for just a few seconds. Furthermore, the inventors address the problem of authentication which usually comes when entering a network, thus allowing emergency messages to be sent using a minimum protocol overhead and, if needed, to be stored and forwarded at a later time by the first node (of a series or set of nodes) receiving the emergency message.

Furthermore, a number of problems regarding open-loop and interrupted-loop communications have to be addressed and solved when acknowledgements and response messages are considered for confirmed and more meaningful emergency communication, especially when closed loop communication (over a longer period of time, for example with emergency calls which are answered by an emergency centre) are not possible.

Furthermore, the non-availability of network coverage will cost significant energy for repeated network discovery and attachment, therefore the inventors consider methods to save either: a minimum amount of phone battery for emergency services; or in case of several devices which can form a kind of device group, sharing their connectivity capabilities either resulting in higher preparedness for communication opportunities or an extended emergency communication duration when operating only one or a few of the devices instead of all of them independently and in parallel.

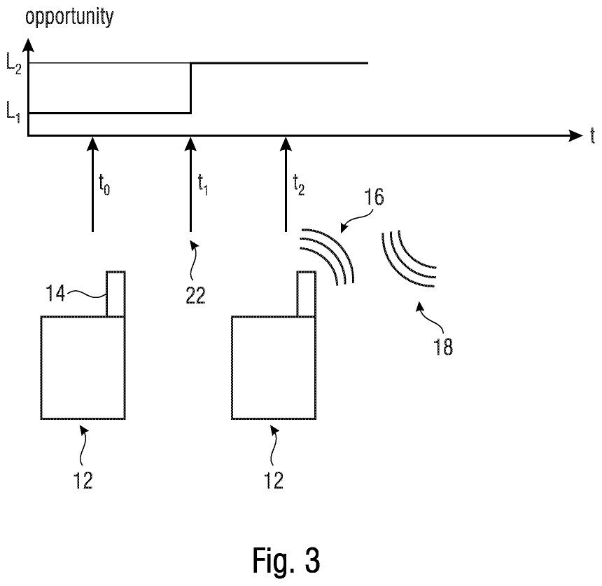

FIG. 3 shows a schematic block diagram of a device 12 according to an embodiment of the first aspect. Device 12 may operate, for example, as a UE, a gNB or an IoT device as described in connection with FIG. 1 but is not limited hereto. More particular, device 12 is not necessarily a terrestrial device but may also be a non-terrestrial device such as a base station being part of a flying device such as an airplane, a balloon or a satellite.

Device 12 comprises a wireless interface 14 such as one or more antennas, antenna panels or antenna arrays. Device 12 is configured to process a wireless signal, e.g., a wireless transmit signal 16, i.e., a signal transmitted by use of the wireless interface 14 and/or a wireless receive signal 18, i.e., a wireless signal received with the wireless interface 14.

Device 12 is configured to schedule the processing of the wireless signal 16 and/or 18 to the occurrence of a communication opportunity 22 that is described at a timeline t to be arranged between two instances of time t₀ where device 12 is unable to communicate, i.e., the opportunity to communicate is at a level L₁ and a time instance t₂ where the opportunity to communicate changes to a level L₂ where communication is possible. A change between level L₁ and L₂ may be referred to as a start of the communication opportunity. The communication opportunity may refer to an availability of a communication path or communication channel, e.g., as being established, re-established or the like. Alternatively or in addition, the communication opportunity may relate to having sufficient resources, e.g., energy, available resources in a time/frequency grid of a wireless communication network with which the device 12 communicates by use of transmission and/or reception and/or relates to other requirements to be fulfilled. As shown for device 12 at time instance t₂, by having the communication opportunity 22, device 12 may transmit wireless signal 16 and/or receive wireless signal 18.

However, instead of waiting for opportunity 22 to occur and to then process signals, e.g., by generating the wireless transmit signal 16 or to adjust filters or the like to signals received, device 12 is aware of the communication opportunity 22 in advance, i.e., at time t₀ or a different instance of time prior to t₁ it expects communication opportunity 22 to happen or to be realized or established and based thereon, device 12 may begin preparation of a later signaling and/or may schedule the processing of the wireless signal to the occurrence of a communication opportunity 22 as being known in advance. For example, device 12 may be ready or prepared at time instance t₁ to almost immediately transmit or receive signals 16/18. Such a concept is to be distinguished from a schedule of TX resources or RX resources that may also be known in advance, however, the device is already in possession of a communication opportunity as being, e.g., in a connected mode or aware of available devices in the sidelink. The reception opportunities may be dynamic opportunities and/or continuous opportunities.

For example, device 12 may have a need, indication, or requirement to transmit the wireless transmit signal 16 but may lack the communication opportunity, e.g., no connection to a receiving device is available. Device 12 may nevertheless prepare for transmission of the wireless transmit signal 16 so that at the time t₁ where communication opportunity 22 is available, device 12 may avoid time to be spent or the preparation of transmission 16 which may allow to a comparatively earlier transmission which is of particular advantage when having only a short amount of time available for the communication and/or a large number of devices waiting for transmission. For example, such a scenario may apply when devices face a relative movement between each other, e.g., having a terrestrial device and a flying device. By being prepared for transmission it allows for a quick, e.g., immediate transmission to thereby use the available amount of time efficiently for communication. Such preparation may be of particular interest, when transmitting, for example, an emergency message or distress message also in view of saving energy. Having prepared the respective message and now by instantly transmitting the message as a prepared message upon communication opportunity 22 becoming available, the device may enter an energy saving mode and/or may require a low amount of energy whilst awaiting the communication opportunity.

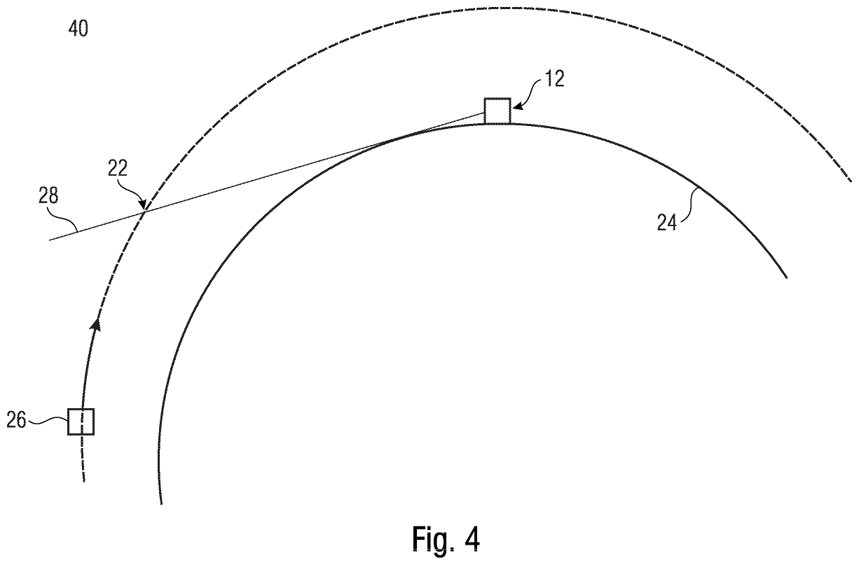

FIG. 4 shows a schematic block diagram of a wireless communication scenario 40 according to an embodiment to illustrate the concept of knowing or expecting a communication opportunity in advance. For example, device 12 is a terrestrial device, located on earth 24, e.g., on the ground either mobile or stationary.

A communication partner 26 is, for example, a flying device such as a satellite travelling around earth 24. With regard to a position of device 12, same may experience a line-of-sight connection to device 26 when same travels or crosses a horizon 28 such that with crossing the horizon 28 there may start the communication opportunity 22. As a flight plan or schedule of device 26 may be known in advance, so may be the time of communication opportunity 22 with regard to the position of the device 12. Therefore, the device 12 when being unable to communicate with device 26, may already prepare transmission of a wireless transmit signal, reception of a wireless signal respectively prior to having the opportunity to establish the line-of-sight connection. It is to be noted, that according to an embodiment, the device may be configured for preparing for transmission and/ore reception at a specific instance of time. However, this is not necessary in all embodiments as a device being prepared for transmission and/or reception, e.g., having TX chains and/or Rx chains prepared may already benefit for the advantages described herein, e.g., when using the occurrence of the communication opportunity 22 as a trigger event associated with an additional, possibly random, delay or with no delay prior to communicate.

Being prepared prior to the communication opportunity may be of particular interest when having only a short amount of time available for communication e.g., when device 12 is located in a canyon leading to only a very small elevation angle available for connecting to device 26. It is noted that this is an illustrative example only, wherein the advantageous effect may be used in any scenario where the occurrence of the communication opportunity is known in advance as in any case the delay of communication may be reduced or avoided by waiting for the communication opportunity.

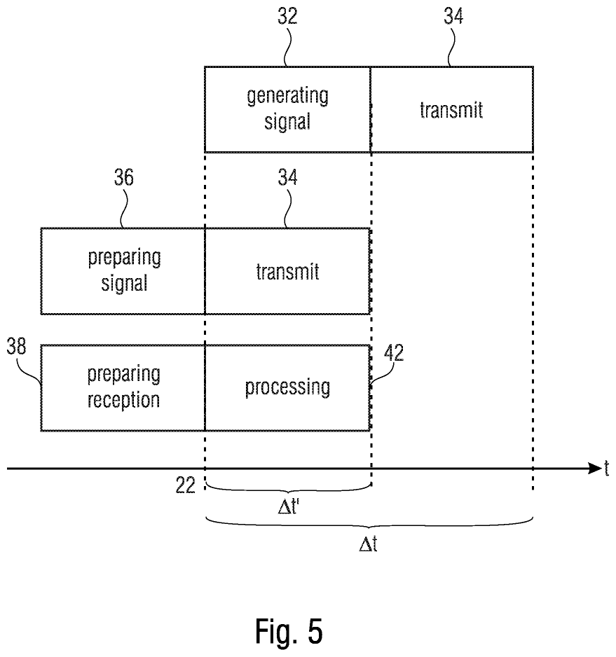

FIG. 5 shows a schematic block diagram of actions to be done for transmitting a signal. In a known procedure, upon having communication opportunity 22 available, a device is generating a signal 32 and transmitting the signal 34 which requires, in total, a time Δt from the occurrence of communication opportunity 22.

According to the inventive approach of the first aspect, a step 36 for preparing a signal may be done directly prior to the occurrence of communication opportunity 22, wherein there may be, additionally, located a gap in time between steps 36 and 34. Thus, upon performing at least a part of step 32 as step 36 prior to the occurrence of communication opportunity 22, a shorter amount of time Δt′ may lapse before transmission 34 is over.

A similar consideration holds for the reception that may also be prepared in a step 38 at least in parts to allow for a quick processing of the signal as being already prepared for reception.

As shown in the illustrative examples of FIGS. 3, 4 and 5, a device according to an embodiment may, for the communication opportunity to comprise a transmission opportunity, generate a message to be transmitted with the wireless signal, see step 36, and for scheduling a transmission of the wireless signal to the occurrence of the transmission opportunity.

Device 12 may use, as communication opportunities, transmission opportunities and reception opportunities allowing for a bidirectional communication, wherein the device is to prepare for a reception, see step 38, and for performing the prepared reception 42 during the reception opportunity.

With regard to FIGS. 3, 4 and 5 and with regard to the communication opportunity to occur, examples were described whilst relating to the dimension of time. First, when referring to a comparison between a transmission opportunity and a reception opportunity, the reception opportunity may be located at a same or different instance in at least one of a time, a frequency, a radio access technology, RAT and/or may relate to a signal that is forwarded by another device such as received as a broadcast and forwarded by a helper device or any other way of distributing communication content. Second, transmission of signal may be prepared during receiving a signal and vice versa as well as embodiments allow for a synchronous preparation of transmission and reception.

Further embodiments relate to evaluating a suitability of the communication opportunity. By way of example, the device 12 has access to information further defining the communication opportunity, e.g., a signal quality or channel quality to be expected, a duration of the communication opportunity, an amount of interference to be expected and/or a number of other devices that are expected to transmit, which may cause, for example, additional waiting time when the communication protocol for a defines a listen-before-talk procedures or the like. The device 12 may further consider its own message to be transmitted and may, in view of the message to be transmitted determine whether to pass the transmission opportunity, e.g., to wait for a subsequent or later transmission opportunity or to use the transmission opportunity to transmit the wireless signal. For example, device 12 may select a transmission opportunity that has sufficient capacity in frequency, data throughput or time to allow for a feedback from the other device or to transmit a feedback to the other device.

As an alternative or in addition, device 12 may consider, advantageously in advance, i.e., prior to occurrence of opportunity 22, whether to distributing the wireless signal across at least two time slots or opportunities, to send a repetition of the same wireless signal or parts thereof across at least two time slots and a distribution of multiple message parts which are encoded by network coding across at least two time slots.

According to an embodiment, there is provided a device comprising: a wireless interface configured for processing a wireless signal. The device is to schedule the processing of the wireless signal to the occurrence of a communication opportunity being known in advance, e.g., it may prepare the activity and may postpone execution.

According to an embodiment, the communication opportunity comprises a transmission opportunity, wherein the device is to generate a message to be transmitted with the wireless signal, and for scheduling a transmission of the wireless signal to the occurrence of the transmission opportunity.

According to an embodiment, the device is to use, as communication opportunities, transmission opportunities and reception opportunities allowing for a bidirectional communication, wherein the device is to prepare, e.g., set filters or the like, for a reception during the reception opportunity, e.g., to enable a (near) real-time or non-real time operation. For example, the proposed device/method may allow a device to use dynamic reception opportunities whilst the transmission opportunities are continuous or persistent.

According to an embodiment, the reception opportunities are dynamic opportunities and/or wherein the transmission opportunities are continuous opportunities.

According to an embodiment, the reception opportunity is located at a same or different instance in at least one of a time, a frequency, a radio access technology, RAT, and/or relates to a signal that is forwarded by another device, e.g., received as a broadcast and forwarded by a helper device.

According to an embodiment, the device is to determine, based on the message to be transmitted, whether to pass the transmission opportunity, e.g., to wait for a subsequent transmission opportunity allowing feedback or the like, or to use the transmission opportunity to transmit the wireless signal, e.g., to use the first and optionally a second opportunity. A transmission of the wireless signal may include: distributing the wireless signal across at least two timeslots; a repetition of the same wireless signal or parts thereof across at least two time slots; and the distribution of multiple message parts which are encoded network coding across the two timeslots.

That is, according to an embodiment, the transmission of the wireless signal comprises at least one of:
distributing the wireless signal across at least two timeslots;
a repetition of the same wireless signal or parts thereof across at least two time slots; and
a distribution of multiple message parts which are encoded network coding across at least two timeslots.

According to an embodiment, the device is to await a feedback associated with the wireless signal via a same or a different radio channel, radio access technology, RAT, and/or route through a wireless communication network in which the device communicates.

According to an embodiment, the device is to generate the message to include information about a connectivity situation of the device.

According to an embodiment, the device is to request information about a transmission opportunity or a reception opportunity wherein the opportunities are either granted or grant-free.

According to an embodiment, the device is to select one of a plurality of transmission opportunities as a selected transmission opportunity to send the wireless signal based on a matching criterion indicating that the selected transmission opportunity matches a requirement of the wireless signal or of the message,

According to an embodiment, the matching criterion relates to at least one of:
a time of transmitting or arriving of the message or of the wireless signal;
a frequency used for transmitting the wireless signal;
a size of the wireless signal and/or provided by the transmission opportunity;
a transmit power;
a transmit power spectral density;
a path loss to the opportunity;
a duration of the opportunity;
a dynamic of the opportunity;
a knowledge of a relationship between transmission and reception opportunities
a knowledge of an achievable throughput related to an opportunity

According to an embodiment, the device is to request at least one additional communication opportunity, e.g., an additional transmission opportunity and/or a reception opportunity. This may allow to avoid scanning.

According to an embodiment, the device is to enter a saving mode prior to the occurrence of the predefined transmission opportunity or a reception opportunity.

According to an embodiment, the device is to prepare the transmission of the wireless signal and to wait for the occurrence of the transmission opportunity.

According to an embodiment, the device is to operate in an operation mode and is unable to use a radio access technology for wireless transmission prior to the occurrence and to have an ability to use a radio access technology for the wireless transmission based on the occurrence.

According to an embodiment, the device is to operate in an operation mode without connectivity to a radio access technology and for using a connectivity based on the occurrence.

According to an embodiment, the device is to prepare the message in a language independent output being independent from a user language.

According to an embodiment, the device is to provide a template to a user of the device, e.g., using a graphical interface, for receiving user input; and for preparing the message based on the user input.

According to an embodiment, the device is to prepare the message at least in parts automated and based on an event, e.g., accelerometers, emergency call (eCall) in OOC, events, conditions, user input.

According to an embodiment, the device is to transmit a signal to at least one other device, the signal containing information about the transmission opportunity.

According to an embodiment, the device is to receive and evaluate a signal from at least one other device, the signal containing information about the transmission opportunity.

According to an embodiment, the communication opportunity comprises a reception opportunity, wherein the device is to prepare, e.g., set filters etc. for the reception during the reception opportunity.

According to an embodiment, the device is to transmit a signal to at least one other device, the signal containing information about the reception opportunity, e.g., to provide other devices with information allowing that the other devices may help receiving a signal.

According to an embodiment, the device is to determine to determine whether to let pass the reception opportunity, e.g., to wait for a subsequent opportunity allowing less errors in reception or the like, or to use the reception opportunity.

According to an embodiment, the device is configured/enabled to select one of a plurality of reception opportunities as a selected reception opportunity to receive the wireless signal based on a matching criterion indicating that the selected reception opportunity matches a requirement of the wireless signal or of the message,

According to an embodiment, the matching criterion relates to at least one of:
a time of transmitting or arriving of the message or of the wireless signal;
a frequency band used for receiving the wireless signal;
a size of the wireless signal and/or provided by the reception opportunity
a receive sensitivity;
a received interference power level;
a path loss to the opportunity;
a duration of the opportunity;
a dynamic of the opportunity;
a knowledge of a relationship between transmission and reception opportunities
a knowledge of an achievable throughput related to an opportunity

According to an embodiment, the communication opportunity relates to at least one of:
1. performing the transmission as a blind transmission using pre-defined frequency resources at a specific time, e.g., as an international maritime distress call, using a terrestrial network, TN and/or a non-terrestrial network, NTN, resource;
2. performing, prior to the transmission, a sensing or listening for network opportunities;
3. performing, prior to the transmission, a sensing or listening for emergency beacons
4. performing, prior to the transmission, a sensing or listening for device-to-device (D2D) sidelink (SL) opportunities
5. transmitting to and/or receiving from a satellite;
6. receiving a signal directed to the device or a different device
7. acting upon or responding to a wake-up signal before transmitting

According to an embodiment, a network comprises a plurality of devices from which at least one device is a device according to one of previous aspects.

According to an embodiment, the network is adapted to determine to reply to a message sent during a transmission opportunity as the communication opportunity by use of a helper device and to instruct at least one other device from plurality of devices to assist forwarding the reply as the helper device and to the device.

According to an embodiment, a method for operating a device comprises:
using a wireless interface for processing a wireless signal;
scheduling the processing of the wireless signal to the occurrence of a communication opportunity being known in advance.

According to an embodiment, a computer readable digital storage medium having stored thereon a computer program having a program code for performing, when running on a computer, a method according to the first aspect.

To address such issues, the inventors propose a solution that may comprise one or more of the following:
User-initiated service activation
   [a free-of-charge service for emergencies]
   [a payable service for status updates]
Form/template-based message preparation
   [language dependent input, graphical/pictorial, →language independent output]
Machine/event-based service actitation
   [accelerometers, emergency call (eCall) in OoC, events, conditions]
Transmission opportunity configuration (examples).
   Blind transmission using defined frequency resources at a specific time (cf. international maritime distress calls) (terrestrial network (TN) & non-terrestrial network (NTN) ephemeris data must be available)
   Listen for network opportunities before transmitting.
   Listen for emergency beacons before transmitting
   Listen for device-to-device (D2D) sidelink (SL) opportunities
   Action wake-up signal before transmitting
Receiving device receiving the transmitted distress signal (a “ping”):
   Parses the message and recognizes its
      Origin, validity, priority, meaning
   Optionally transmits a “pong”
   Processes and makes decision(s) [automatic, human-in-the-loop, AI-assisted]
   Optionally transmits a response message. Examples include:
      Evacuate, turn off electricity, take cover, listen to local radio, prepare for future, transmit and receive opportunities and/or configurations.
Configure or trigger the UE to change mode 1 . . . 5
Receiving device informs a distressed UE about further information exchanges to/from response centre (forward after M-minutes, do not expect an answer before N-minutes)

This may comprise to prepare for a communication opportunity, e.g., being or comprising at least one transmission opportunity and/or at least on reception opportunity.

### Aspect 2

According to a second aspect, embodiments relate to collaborative device (e.g., UE) group communications. The inventors have identified a problem in known systems as follows.

Communication availability became a commodity over recent years and the lack thereof is often considered inconvenient at least or having negative effects on the usual way we interact with others in business, travel or private life. As an example, a group of people each equipped with a smart phone is travelling abroad outside of the usual coverage area of their home networks provided by their mobile network operators (MNOs), thus requiring roaming to other networks. While each member of the group is used to having coverage most of the time in his home area, the coverage experience can be very different when travelling abroad or going to remote areas.

In such situations, either a tremendous amount of (battery) energy is spent for network discovery, reconnections, roaming etc., while at the same time not all members of the group experience coverage/connectivity at the same time or at significantly different quality levels.

Therefore, the focus of the embodiments related to the second aspect address the stated problem by forming a group of devices that may allow a device to help at least one other device of the group. This may allow resolving unequal communication opportunities/capabilities of the different devices and thus exploits the inter-device connectivity option (also known as device-to-device (D2D) communications) to share and distribute the different communication options among members of the UE group. This concept addresses the issue of the differing connectivity experienced by the different devices in the UE group and the associated (battery) energy needed to identify, establish and maintain connectivity to the network for each and every member of the UE group.

Embodiments target resource sharing and messages to and from the network when one or few of the members of the UE group are not directly connected to a base station of a network but instead indirectly via a D2D link to another member of the UE group and then to the network. The related signalling in particular addresses states of idle and/or inactivity of UEs, while still being pageable from the network side for incoming calls or data when needed.

The inventors have recognised that by forming a group of devices that aims to compensate for communication deficiencies of certain members of the group, an increased reliability of message sending from the device, e.g., to outside the group and/or message reception, e.g., from outside the group to one or more members may be obtained even if the devices operate by use of different radio access technologies, RATs, and/or are operated by different MNOs.

To address such issues, the inventors propose a solution that may comprise one or more of the following:
According the second aspect, the inventors found that it is of advantage to provide for a group-wise service, e.g., for relaying calls or messages or otherwise providing communication service for one or more members of a group, receiving such communication service from one or more members of the group respectively. Some embodiments of the present invention are based on the finding that by forming a group of devices, such group may negotiate details about providing communication, e.g., selecting a most suitable device for providing service for the group or a part thereof and/or devices for receiving such service. This extends known relaying concepts by implementing a group that may be a set of devices or entities that may decide whether another device is considered to be a member of the group or not. That is, when compared to known relaying concepts, e.g., in the field of D2D-communication, such services is only provided for members of the group.

That is, according to embodiments, tasks to be executed such as communicating with one or more networks outside the group, distributing information and organizing the group may be scheduled and/or organized within the group.

By way of non-limiting example only, the group may select a member or device having the highest remaining battery capacity for maintaining communication with one or more entities outside the group, e.g., with the internet or with the mobile communications network whilst distributing the communication in an energy-efficient manner in a D2D-communication within the group. Whilst avoiding other devices to perform communication with external devices, this increases the energy consumption at the selected device. As a further example that may be combined with a concept of using the highest energy level, the device having the most reliable or experiencing the highest quality of the channel may be selected for external communication. Thereby other members of the group may be prevented from experiencing bad channels, executing (erroneous) procedures to establish connections and/or requiring a high amount of retransmissions. Other examples relate, as an alternative or in addition, to select a device as a relay or distributor of messages and/or information within the group that is the most suitable device according to an optimization criterion such as energy level/battery capacity, channel quality, expected future events such as recharging, moving to or staying at a specific location within the group or as a geolocation or others.

In view of the concept relating to a group of devices, embodiments relate to joining a device to the group, e.g., upon request or autonomously, e.g., based on predefined mechanisms, and/or to removing a device from the group.

Embodiments relating to the second aspect also relate to modifying or amending the group, e.g., in view of the group members/devices and/or the purpose of the group or a role of one or more devices within the group. For example, upon experiencing a change in the overall scenario, e.g., with regard to the battery capacity or the data throughput capability, roles within the group may change. As an example, a group of devices may select, as being possibly the only or most promising communication channel, one of the devices to communicate with a flying device such as a satellite to receive messages or data for the group. Upon obtaining a more suitable communication opportunity, e.g., in view of monetary costs, energy consumption, computational costs or the like, a different device may connect, e.g., to a terrestrial base station to re-structure the group, e.g., by change of the relaying device/service provider to the device that connects to the terrestrial base station. For example, the group or a part thereof may move or change a location or at least a relative position to a communication partner which might affect, for example, only a part of a group, for example, when a base station of a specific MNO comes within range which is helpful for at least a subset of the group only. A decision to re-organize the group may be made by a group-operator or group administrator, by one or more of a set of group-operator devices or group administrator devices and/or may be made according to a deterministic scheme and/or based on negotiation, e.g., allowing to reject a role by an operator or user of one of the devices.

Further embodiments according to the second aspect relate to inviting a device to the group or denying entry to the group.

Further embodiments relate to a concept being referred to as group of group GOG, which may also be considered as, an opposing hierarchical order, as sub-groups of a group. This allows for increasing degrees of freedom for controlling devices.

With regard to the second aspect, according to an embodiment, a device, such as a UE, for operating in an wireless communication network and for operating as a group member of a group of devices is provided. Such a group of devices may be associated, subscribed or operated by same or different mobile network operators, MNOs. A sidelink communication in accordance with embodiments is not necessarily limited to one or several MNOs. It may be operated, for example by only one RSU operator in a particular area or UEs rely on fallback modes when there is not network at all, e.g., in out-of-coverage, OOC, scenarios.
a) The device is configurable for providing a communication service, e.g. a capability such as reachability, message/information forwarding, bandwidth, reception awareness or the like, for at least one different member of the group, e.g., in addition and/or instead of the MNO of the different member; and/or
b) The device is configurable for receiving a communication service from a different member of the group, e.g., in addition and/or instead of the MNO of the different member.

According to an embodiment, the device is for joining the group
a) to conserve a resource of the different member; and/or
b) to conserve a resource of the device.

According to an embodiment, the resource comprises one or more of:
a battery level;
a communication resource such as SMS, MMS, data contingent, communication contingent; and
amount of low-level radio resources (time, frequency, sequences, spatial resources) for a transmission/reception opportunity to be filled with control or data signals to communicate to a member in the group or to the network and the associated energy needed for processing and transmission/reception of the signals.

According to an embodiment, the device is to coordinate, for one or more resources and with at least one other member of the group, a type of the resource and/or an extent to which the resource is shared, e.g., based on an energy constraint, a user demand, a user capability and/or a network coverage.

According to an embodiment, the device is for joining the group
a) to provide an increase in connectivity such as reliability, throughput, bit errors, reduced latency or the like, of the communication service for the different member; and/or
b) to increase reliability of the communication service via the group.

According to an embodiment, the device is for sharing a connectivity or radio access technology, RAT, with at least one different member of the group.

According to an embodiment, the device is for directly or via an additional member of the group, forwarding a call or a message or a data stream to or from a target member of the group to the wireless communication network. This may but is not required to include a generation of an additional hop for the message to or from the other member.

According to an embodiment, the different member is operated by a different mobile network operator, MNO, and/or operates by use of a different radio access technology, RAT.

According to an embodiment, the device is for joining the group in accordance with a group forming information indicating an availability or unavailability, a preference or a restriction about a formed group, e.g., comprising a use of a group policy, an MNO agreement/contract, a user-centric option including at least one key performance indicator, KPI, instructions provided by a level of authority an event, a service class required or a configurable closed-user group.

According to an embodiment, the device is for, jointly in the group of devices, to provide communication service for at least one different member of the group that is out-of-coverage from its mobile network operator, MNO.

According to an embodiment, the device is to join the group based on a received invitation signal. Such a signal may be originated in the group or external the group.

According to an embodiment, the device is to operate according to a specific capability requirement indicated in the invitation signal, the specific capability requirement indicating at least one communication service provided by the group for the device and/or at least one communication service requested from the device.

According to an embodiment, the device is to request to join the group based on a received group identification signal. For example, the request may lead to a reaction based upon which the device is granted access to the group wherein access can be granted by a member of the group; a group member with certain privileges, according to a group policy, another network entity e.g. the access request is forwarded to a core network.

According to an embodiment, the invitation signal is provided by a group member or from an entity outside the group.

According to an embodiment, the invitation signal is provided by an entity outside the group, e.g., based on a prediction or calculation of a wireless communication network.

According to an embodiment, the prediction or calculation relates to at least one of:
a provision of coverage,
a quality of service, QoS,
a capacity,
a throughput,
a latency,
a reliability

According to an embodiment, the device is to join the group based on a user command.

According to an embodiment, the device is to join the group based on a predefined event detected by the group or by the device.

According to an embodiment, the device is to join the group based on a service offered to the device by the group, e.g., the group offering a form of message brokerage so as to reduce the signalling between the devices of the group and the network.

According to an embodiment, the device is to join the group based on a network assistance information such as information representing a coverage map.

According to an embodiment, the device is to join the group based on a predefined group configuration information indicating at least one of the group members, a type of the device and a group identification.

According to an embodiment, the device is for accessing a database containing information indicating one or more conditions to join the group or to leave the group.

According to an embodiment, the device is for using, from the database information indicating a location, a coverage per mobile network operator, MNO, a coverage per radio access technology, RAT; and or information indicating a capability, an availability, a load prediction, one or more load requests/reservations/restrictions.

According to an embodiment, the device is for selecting the group as a selected group from a plurality of available groups.

According to an embodiment, the device is to select the selected group based on a complimentary capability with respect to a capability of the device.

According to an embodiment, the device is for refusing joining of the group responsive to a refusal criterion.

According to an embodiment, the device is for operating as a member of at least two groups in parallel.

According to an embodiment, the device is for signalling, to at least one other member of the group a connectivity information indicating a connection of the device to be used as at least a part of the communication service.

According to an embodiment, the device is for signalling to at least one other member of the group, a capability information indicating at least one of:
a connectivity of the device to at least one network entity, NE, e.g., at regular intervals or upon changes of their connectivity; and/or
a connectivity of another device to at least one network entity, NE, e.g., at regular intervals or upon changes of their connectivity.

According to an embodiment, the device is for initiating formation of the group by transmitting an initiation signal.

According to an embodiment, the device is for negotiating with at least one other member of the group about a leadership of the group.

According to an embodiment, the device is for operating in the group according to instructions provided by a group leader device, the instructions indicating an assignment of services or resources to be provided by different group members for the group.

According to an embodiment, the device is for determining an assignment of services or resources to be provided by different group members for the group and for signalling, to the group instructions indicating the assignment.

According to an embodiment, the device is for operating as a network anchor for at least one other member of the group; and/or for operating as a gatekeeper for the group and/or for operating as a broker of data associated with the group. A gatekeeper may decide whether a message is forwarded to the group and/or may bundle a/the communication. A broker may distribute communication.

According to an embodiment, the device is for signalling, to the wireless communication network information about one or more of
a status of the group;
a location of the group;
information about the group members such as battery status, interconnectivity, forwarding IP addresses, MNOs of the group members, device IDs, MAC addresses, IMSI, capabilities.

According to an embodiment, the device is for cooperative and/or collaborative connectivity resource management.

According to an embodiment, the device is for forwarding a call or message of the different member together with a request to forward the call or message to another member of the group.

According to an embodiment, the device is for receiving a wireless signal containing a message and for evaluating the message for an information that the message is to be within the group, e.g., by using a group identifier identifying at least one intended recipient, and for distributing information derived from the message, e.g., a new signal forwarding the message or other information generated responsive to the message, to provide the communication service.

According to an embodiment, the device is for transmitting a signal to at least one other member of the group, the signal containing a message comprising information indicating identifying the device as being a member of the group, e.g., by including a group identifier or a flag into the signal.

According to an embodiment, the device is for requesting to receive the communication service from at least one member of the group and is for transmitting a signal to at least one other member of the group, the signal containing a message comprising information identifying a forwarding requirement, such as a type of content, a priority class, a reception time requirement or the like.

According to an embodiment, the device is for providing the communication service to at least one other group member and is for evaluating a received signal for an information identifying a forwarding requirement of the signal, such as a type of content, a priority class, a reception time requirement or the like; and is for deciding whether to forward or not the signal in the group based on the forwarding requirement and/or is for determining a sequence of a plurality of signals to be distributed based on a corresponding plurality of forwarding requirements.

According to an embodiment, the device is providing a list of proxy options to the network, wherein the proxy options are identifiable as the at least one other group member and wherein the list can be unordered or ordered according to criteria, e.g. priority, capability, urgency, etc. and wherein the network can be informed about further criteria which may request in a call or connection initiation via one of the proxy options at a time, one option after another or several options in parallel, the latter to initiate either a multitude of link options to the device or to reduce the latency in call/connection setup.

According to an embodiment, the list of proxy options is adapted to inform a home network of the device about options how the device can be reached when not connected to the network anymore or when being out of coverage, e.g., the device may forward an IP address to its home registry, to become a proxy address for incoming calls, messages or data services. For example, in many phones and operating systems, OS, such a mechanism may be implemented as so-called Wi-Fi Calling, which allows a phone to be reached/paged via any IP-connection when not connected to a cellular network via roaming, e.g. when the user is travelling and uses Wi-Fi in a hotel or public place. This known mechanism relies on an active internet connection from the device to its home network and will not work if the IP address provided from a local Wi-Fi hotspot is changed and not updated in the home directory of the home network, an issue solved with this invention.

According to an embodiment, the device is for generating the request as additional request.

According to an embodiment, the device is for sidelink relaying a call or message to the different member being operated by a different mobile network operator, MNO.

According to an embodiment, the device is for receiving via a direct device-to-device relaying a call or message from the different member of the group being operated by the same or different mobile network operator, MNO.

According to an embodiment, the device is for skipping providing the communication service based on a decision criterion such as a priority; an order of users for forwarding; and/or an order of messages for forwarding; and/or for
for skipping providing the communication service based on a load criteria of the device such as a limited number of (parallel) sessions, e.g., forwarding to one device, forwarding to two devices, forwarding to N devices; and/or
for skipping providing the communication service based on knowledge about alternative link options for the other device, wherein the alternative link options are already established, in preparation to be established or can be established with reasonable probability; and/or
for skipping providing the communication service based on a feedback mechanism of the communication service.

According to an embodiment, the device is for providing the communication service as supplementary communication service for the other member, supplementing a connection of the different member to its mobile network operator, MNO or via another member of the group via the mobile network operator, MNO of that other member.

According to an embodiment, the device is for providing the communication service as substituting communication service for the other member, substituting a connection of the different member to its mobile network operator, MNO.

According to an embodiment, the device is for operating, for the group of devices as a message distribution point in downlink direction and/or as a message aggregation point in uplink direction.

According to an embodiment, the device is for operating, for the group of devices as a message aggregation point in downlink direction and/or as a message distribution point in uplink direction.

According to an embodiment, the device is for leaving the group based on a leave criteria comprising at least one of:
a number of remaining devices being below a device threshold;
a capability of at least one device falls below a predefined threshold;
a capability of at least one device exceeds a predefined threshold;
a link parameter or connection parameter of at least one device falls below a predefined threshold;
a link parameter or connection parameter of at least one device exceeds a predefined threshold;
a link parameter or connection parameter of the device exceeds a predefined threshold;
a leaving instruction received from the wireless communication network;
a user command.

According to an embodiment, the device is for dissolving the group or excluding at least one member of the group, e.g., by signalling a dissolve information, based on at least one of:
a number of remaining devices being below a device threshold;
a capability of at least one device falls below a predefined threshold;
a capability of at least one device exceeds a predefined threshold.
a link parameter or connection parameter of at least one device falls below a predefined threshold;
a link parameter or connection parameter of at least one device exceeds a predefined threshold;
a link parameter or connection parameter of the device exceeds a predefined threshold;
a dissolving instruction received from the wireless communication network;
a user command.

That is, a link parameter can be or can comprise one or more of coverage, reliability, provided data rate, latency etc. which may be understood as possibly, if other members of the group don't provide sufficient benefit for the device to remain a member of the group and/or if the device is sufficiently well connected to its network and therefore can continue services without being a member of the group anymore, the group may be dissolved or at least one device may be excluded or may exit the group.

According to an embodiment, the group of devices is a first group; wherein the device is for simultaneously establishing a wireless connection to a wireless device being a member of a second group.

According to an embodiment, the group of devices is a first group and wherein the device is to simultaneously operate as a member of a second group, wherein the device for establishing a first wireless connection to a member of the first group and for establishing a second wireless connection to a member of the second group. For example, this may cover a situation when the device is configured to be a member of a first and of a second group, e.g. by default or by another entity AND the device is not acting as the bridging device between the two groups but is only providing an active link or service to a member of one of the groups.

According to an embodiment, the device is for providing a communication service to the second group and/or for receiving a communication service from the second group.

According to an embodiment, the device is for joining the second group or to include a member of the second group into the first group. A decision criterion may be pre-defined or decided, if required.

According to an embodiment, based on the first group and at least the second group forming a third group being a group of groups, the device is to associate itself with the second group instead of the first group such that in a case where the group of groups is dissolved, the device retains membership of the second group instead of the first group.

According to an embodiment, based on the first group and at least the second group forming a third group being a group of groups, the device is to operate as a member of the group of groups according to an operation in the first group and/or the second group.

According to an embodiment, the device is for preserving a predefined amount of resources available for the device for using the preserved amount of resources for providing the communication service.

According to an embodiment, the device is for receiving an instruction indicating the predefined amount and for operating accordingly.

According to an embodiment, a group of devices comprising at least one device according to one of previous aspects, the group sharing a communication service.

According to an embodiment, the group is a first group and devices of the first group are for forming a joint second group with one, a plurality or all devices of a third group of devices, e.g., following a request from a member of the first group or of the third group and/or responsive to instructions received from a network operating at least one device of the first group or the third group.

According to an embodiment, wireless communication network comprising a group of devices having a plurality of devices from which at least one is a device according to one of previous aspects,
wherein the device is for receiving the communication service via at least one other group member informing the network, e.g., advantageously its home network, about at least one other group member to act as a proxy device for the device for at least one of an incoming call, a message and a data service, wherein the network is provided with parameters to identify the proxy device, e.g. telephone number, IP-address, related network, paging area, etc., wherein the at least one other group member configured for acting as the proxy device is enabled for evaluating a received signal for an information identifying a forwarding requirement of the received signal, such as a type of content, a priority class, a reception time requirement or the like and the device it is to be forwarded to;
wherein the device is for deciding whether to forward or not the signal in the group based on the forwarding requirement and/or is for determining a sequence of a plurality of signals to be distributed based on a corresponding plurality of forwarding requirements.

For example, the device is informing the network about a list of options when the device cannot be reached directly. The forwarding options can include one, some or all other members of the group to act as forwarding proxies. Such a mechanism may allow the device to inform its home network about the options how the device can be reached, when not connected to the network anymore. This mechanism differentiate from known concepts, where the device may forward an IP address to its home registry, to become a proxy address for incoming calls, messages or data services. As described, in many phones and OS this is implemented as so-called Wi-Fi Calling, which allows a phone to be reached/paged via any IP-connection when not connected to a cellular network via roaming, e.g. when the user is travelling and uses Wi-Fi in a hotel or public place. This known mechanism relies on an active internet connection from the device to its home network and will not work if the IP address provided from a local Wi-Fi hotspot is changed and not updated in the home directory of the home network.

A wireless communication network comprises at least one infrastructure entity and at least one associated device, wherein the wireless communication network is for determining that a network service is currently or in future insufficient for the associated device and/or a different device and for initiating formation of a group of devices to jointly use network capabilities.

According to an embodiment, the communication network is for using initiating the formation of the group based on information of one or more of:
a presence or expected presence of one or more devices;
a present or expected location or area of one or more devices;
a connectivity capabilities of the device and/or
an expected/predicted Quality of service, QoS, experience.

According to an embodiment, the wireless communication network is implemented on a road vehicle, a ship or on a flying vehicle or a space vehicle. As a road vehicle, there is not excluded a dockside crane; a railway wagon/locomotive; a warehouse/factory floor vehicle; an agricultural or other off-road vehicle, and so on. As a ship, there is not excluded a buoy; a barge; a floating crane; a drilling platform, an offshore wind turbine, an unmanned maritime survey vessel and so on.

According to an embodiment, the at least one associated device is a device according to one of an implementation of the second aspect.

According to an independent embodiment, a method for operating a device, such as a UE, for operating in an wireless communication network and for operating as a group member of a group of devices is provided, the method comprising:
a) configuring or operating the device to provide a communication service for at least one different member of the group; and/or
b) configuring or operating the device to receive a communication service from a different member of the group.

According to an independent embodiment, a computer readable digital storage medium having stored thereon a computer program having a program code for performing, when running on a computer, a method according to the second aspect.

### Generating, Forming or Defining a Group

### 1. The Group May be Intrinsically Formed by One or More Group Members

a. Motivation of a Device, UE, to Form a Group, e.g., User Activated

A UE can join a UE group for different reasons, for example: to conserve (battery) energy itself and/or for other members of the group; to be provided with improved (less frequently interrupted) connectivity; to reduce latency; to increase throughput in UL and/or DL; to ensure greater reliability through the use of redundant links; to have access to frequency bands and/or RATs that are not supported by all devices (aggregation/sharing of connectivity options).

i. Basis of Information/Trigger to Invite Others to Join the Group

A device can be asked/invited to join the group through the invitation of its human user (the person using/owning the device) through proximity in response to another device asking for a “link buddy” or “helper” or “group formation”, in response to an activator (vehicle accident, airbags inflated, collision, smoke detectors). Further information could include, for example, another UE transmitting a “group formation” signal. The invitation message (potentially broadcasted) may contain specific capability requirements in order to complement the existing capabilities of the group.

ii. Basis of Motivation to Join a Group

For example, an expected improvement in link quality, connectivity, energy saving, redundancy, reliability. The device would accept invitations (“group establishment request(s)”) to join a group according to a configuration of the device (“group formation enabled”).

The formation of a group comprised of several devices may also result in for example: reducing signalling overheads; statistical multiplex (channel bundling, channel coding according to content). The group may also offer a form of message brokerage so as to reduce the signalling between the devices of the group and the network.

iii. Possible Assistance of the Network

Although being even more relevant to the next section, extrinsic group formation, the network may also assist in forming an intrinsic group.

The network can provide assistance information through, for example, the provision of coverage maps (including temporal data such as ephemeris). The network can also instruct targeted UEs to form a group—for example, when loading containers onto a container ship, the owner of the cargo in the containers and/or the owner of the containers wishes the containers to be grouped in a defined manner. The signalling instructions for creating and/or configuring the group are sent via the network to the UEs.

iv. Content of a Database Assisting the Group

Location, coverage per MNO, coverage per RAT, according to capabilities, according to availability, according to load predictions, according to load requests/reservations/restrictions. Forming of the group may, thus, be location-based and/or trajectory-based, e.g., based on a path and/or route.

b. Motivation of the Device to Join the Group

When being a member of the group, the member's QoS might be better than when not being a member of the group, see also 1-a-ii (Basis of motivation to join a group)

i. In One Example, to Allow the Joining is a Straight Forward Approach Based on a Received Request, e.g., the Device Helps if Capable

The “new member”, e.g., the device that has joined, may also choose a certain group from a plurality of available groups, e.g., because complimentary capabilities are on offer, see also 1-a-ii (Basis of motivation to join a group). That is, the device may select one or more most suitable groups to join or to request joining.

ii. Motivation to Refuse a Device from Joining the Group (e.g., Low Battery, No Own Service)

For matters of, for example, privacy, purpose, security, incompatibility, expected/anticipated paths (not going or travelling to the same destination or taking the same route together) a device may choose not to join a group, e.g., although being invited. Alternatively or in addition, a device such as a UE might already be a member of one or more groups and may thus decline the request to join another group because, for example, it does not have the capacity to form or join an additional group and/or the existing grouping is already satisfying its need(s) to be part of a group.

According to an embodiment, a device in a group of devices, e.g., a such as a UE in a group of UEs may have the ability and/or may be configured/configurable to alert other devices/UEs that it is “connected” (to cellular, NTN, some other RAT). This may provide knowledge which device and/or which group may provide for needed assistance.

### 2. The Group is Extrinsically Formed, e.g., by a Higher Entity

The group can be formed by, for example, a network recommendation, an existing group that wishes to connect resources with other devices and/or with other (existing) groups. As an example, at a given location or in a given region, maximum connection diversity would be provided by a plurality of RATs which are described in the “recommendation”, see for example 1-a-iv (What is the content of a database assisting the group).

a. Entity Allowed to Initiate the Formation of a Group

Any device that is motivated to form a group may initiate the formation of a group. Some devices may choose not to initiate the formation of a group however (and instead might decide to join existing groups or to refrain from all forms of group membership). Particular devices may be entitled by the network to become group leaders (due to their features, contract, capabilities, security clearance, authority). Such a UE might become a network anchor for the UEs of the group and might also act a gatekeeper for the group and as a broker of data into and out of the group.

i. Reason and Result of a Group Formation Trigger

A network (e.g., including: cellular; NTN; any network such as Wi-Fi, LiFi, IoT, LoRa) may have sufficient information to form the group and may trigger the formation.

Basis for the trigger: The network anticipates that its provision of coverage, QoS, capacity, throughput, latency, ad/or reliability cannot match predicted demands. Such predictions might be based on UE requests, UE activity, UE movement (from outdoor to indoor, from land to sea, from land to air, UEs with similar location and speed changes [within a vehicle]), UE link stability or other known or expected events for example, natural disasters, unwanted events, security violations, attacks, threats, etc.

Result: Resilient connectivity for group members compared to non-grouped UEs that may suffer link loss/degradation.

An Event (e.g., battery monitoring, location awareness) may be at least a part of a trigger triggering the formation.

Basis for the trigger: Battery level drops below a threshold. Entering a geofenced area of patchy coverage.

Result: Sharing and conserving energy resources for longevity. Sharing resources to improve connectivity.

### Geolocation, Orientation

Basis for the trigger: Given the known/estimated/predicted geolocation or orientation, connectivity is not possible (out-of-coverage).

Results: Preserve battery energy. Avoid attempts of direct connectivity. Achieve indirect connectivity via group members.

b. Entity with Sufficient Information to Form the Group
i. For Example, as Described in Section “Network Triggered” or Extrinsic Formation of a Group

A network (including: cellular; NTN; any network such as Wi-Fi, LiFi, IoT, LoRa) may trigger the formation of a group providing that it has information of, for example, the presence or expected presence of UEs in a give area, the connectivity capabilities of the UE and/or the expected/predicted QoS experience.

c. Extrinsic Motivation—Joint Goal—for Forming the Group
Purpose and/or Goals of the Group

To jointly operate in a more resourceful mode than when compared with independent operation (UE-by-UE basis).

Alternatively or in addition, to reduce signalling overhead associated with regular updating of UE information, for example, location. Instead the location of the group (or at least one member of the group) is regularly reported.

### EXAMPLES

1. A group of UEs operate/operating in a collaborative mode of operation
a. e.g. a group of hikers manage their communication devices in order to conserve resources that are not limited to include: battery capacity; number of SMSs; number of MMSs; minutes of calling; quantity of bytes.
b. e.g. devices are pre-configured as a group of UEs to operate functions which can be used for energy management in special applications such as emergency calls/messages and in special situations such as the preparation of messages in emergencies
c. e.g. a group of UEs which are subscribed to more than one MNO are at a certain location where only one of the UEs of the group of UEs is provided with coverage from one of the MNOs and all of the other UEs are out-of-coverage from their own MNO.
d. One device is sending the status and location of the group and information about the group members (battery status, interconnectivity, forwarding IP addresses, MNOs of the group members, device IDs, MAC addresses, IMSI, capabilities)
e. If a call or message comes in, it can be forwarded to each or any directly-connected member of the group if it cannot be routed directly to the target UE that has requested or supports forwarding calls/messages/paging
f. Container ship with some containers having NTN connectivity that can provide outbound connectivity when the ship is at sea. Other containers without such connectivity or that are out-of-coverage form/join a group that has connectivity.

2. The shared aim of members of a group according to embodiments:
The aim of the group is to achieve a form of connectivity resource management that is either cooperative, collaborative or a combination of the two. In a cooperation, members of the group work together in order to achieve goals which are individual and user-centric. In a collaboration, the group works together to achieve a common or group goal. The group may also work to achieve a combination or compromise of the two types of goals, individual- and group-oriented.

### Details Related to Operating/Utilizing the Generated Group

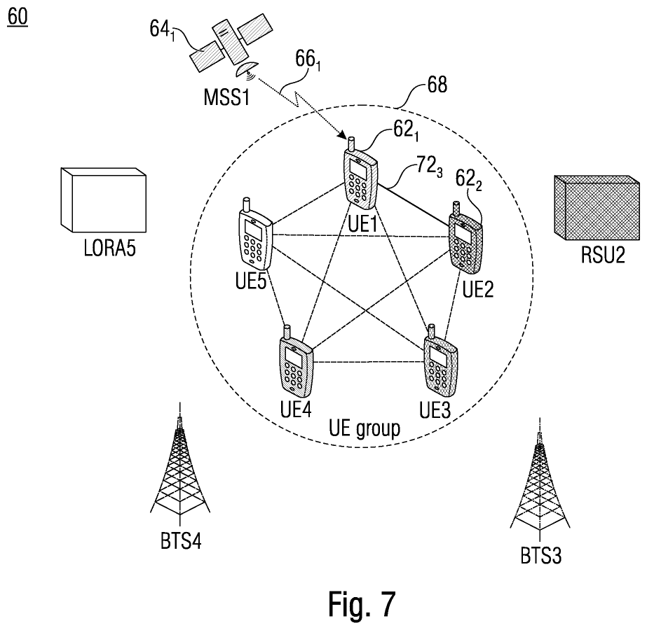

1. Basis for a Mechanism Allowing an MNO (RSU2) to Reach UE 2 when Only UE 1 has a Connection (See FIG. 7)

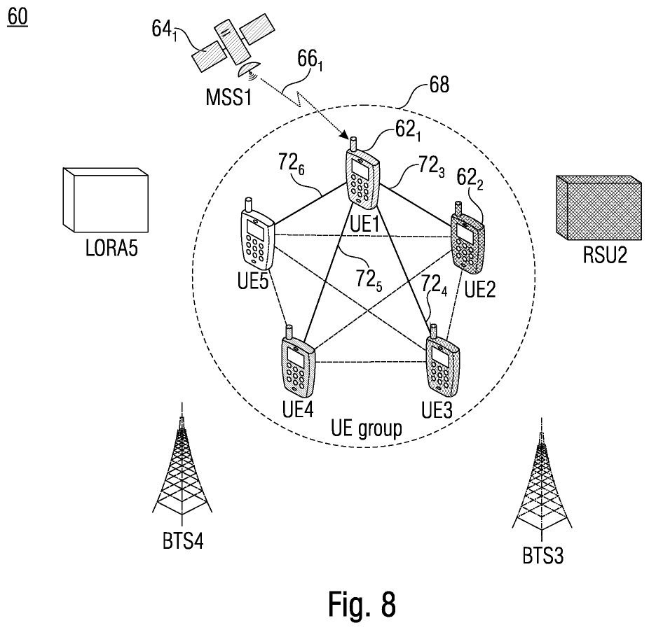

There are at least four potential options.
Using an eCall. Having the IP address of UE2 when being indirectly connected via UE1 to the Internet (similar to Wi-Fi calling) and according to the protocols used in each solution.
Traditional call forwarding. UE1 is called instead of UE2 (users have to hand over phones manually). The users have to agree between themselves how to handle calls.
Call or message is forwarded to UE1 with additional request to forward/route message or call to UE2 (MNO does not need to have detailed knowledge [IP address] of the connection between UE1 and UE2). According to the protocols used in each solution.
Sidelink relaying, UE1 is associated with MNO1 and UE2 with MNO2. UE1 and UE2 are connected by sidelink. UE1 is considered by MNO1 to operate as a relay for UE2 (thus far the standard allows such a configuration when both UEs are serviced by the same MNO but not by different MNOs). According to the protocols used in each solution.
   2. Basis for which Mechanism UE1 Decides to Forward (or not to Forward) Messages (See FIG. 8)

Such a mechanism could be configured according to: one or more of priorities; order of users for forwarding; or order of messages for forwarding. Furthermore, as an alternative or in addition, a limited number of (parallel) sessions—forwarding to one UE, forwarding to two UEs, forwarding to N UEs—can be defined.

Mechanisms can also be defined, as an alternative or in addition, according to: near real-time (or closed-loop protocols); or store-and-forward. For example, a messenger message using end-to-end encryption needs to operate in a closed loop manner when the UE is sharing its IP address so that the server can respond with a message. On the other hand, an SMS can be handled with the latter.

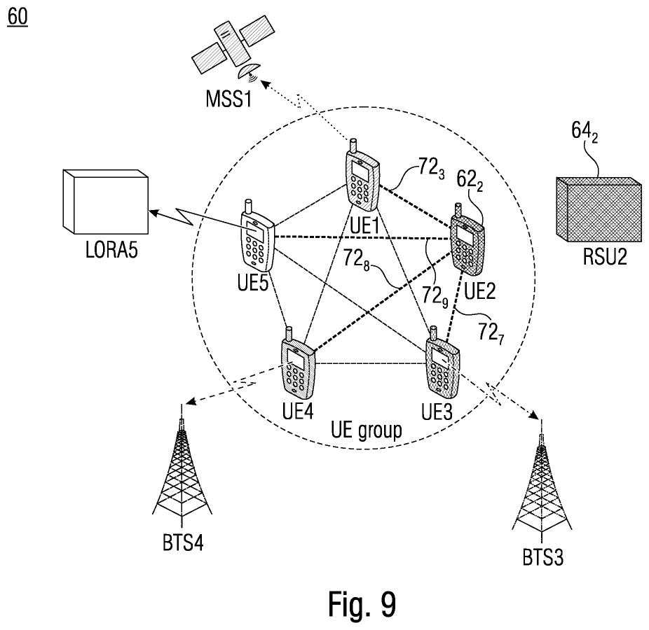

### 3. UE 5 Also Forward Something to UE4 (See FIG. 9)—Use Case for Such an “Additional” Hop

FIG. 9 is UE-centric and shows how UE2 uses the other UEs to achieve a connection to a NWE. FIG. 9 shows that UE 5 is connected to a LoRa basestation/network which might have data rate limitations. For certain applications large data packets need to be conveyed. Therefore, the other connections can be used to increase the overall throughput.

4. Reason for UE 3, UE 4 and UE 5 to Use UE 2 as an Additional Hop Rather than Using the Connection Via UE 1, See FIG. 9

Although being not excluded according to embodiments, as FIG. 9 is UE-centric and shows how UE2 uses the other UEs to achieve a connection to a NWE, this may be based on an implementation using a single hop.

### 5. Difference Between Downlink and Uplink Mechanisms

a. Does an external unit aware of the group perform some DL “group message” expecting distribution in the group?

To the one or more NWEs, the group can either be seen (group awareness) or not be seen (transparent). In DL the forwarding UE can be considered as a message distribution point.
b. Does the group share a message expecting at least one unit (if possible) to provide the MNO with the UL message if/as soon as possible?

In UL the forwarding UE can be considered as a message aggregation point. The group can agree to send a “group” position (valid for the devices forming the group).

Two methods of addressing the group or the members of the group and exchanging messages with are described: a) procedure-related; and b) signalling-related. In a procedure-related exchange of messages with the group, the NWE interacts in a manner that is (slightly) different to that used when interacting with a single UE. In a signalling-related interaction, the messages contain additional information that tells the NWE it is interacting with a UE group.

Forwarding options include Layer-2 and Layer-3 relaying. Layer-2 relaying may be understood as that the final target needs to be known by the external NWE (RAN) whilst in Layer-3 relaying the final target may remain hidden behind the relay and is identifiable by its IP address only (similar to a Wi-Fi hotspot).

### 6. Reconnecting a Formerly Out-of-Coverage, OOC, Device to the MNO Through the Group

The device may update its position and its valid IP address. It does not necessarily have to inform its MNO that it is part of a group. Alternatively, it may share the IDs of other group members with the MNO if they are a member of the same or a different MNO.

7. Grouped Devices Announcing that their Services as Still Available

The group members may announce to other group members their connectivity to NWEs at regular intervals or upon changes of their connectivity (when lost and/or when gained).

### 8. Self-Restriction of Device Exploitation

A restriction can be implemented using, for example, a group policy, an MNO agreement/contract, a user-centric option that might include various KPIs. However, such restrictions might be overruled by an entity according to: a level of authority; certain events (disaster, emergency); a real-time need (service class).

### 9. Negotiation of Device Services and Device Service Provision

Negotiation might increase the complexity of group formation. However, it might ensure that similar capabilities are shared on a fair and reasonable basis. Alternatively, the extent of service sharing might be defined by the lowest common denominator of the group, i.e., the UE with the poorest connectivity capabilities. Aspects related to the extent to which services are shared may comprise one or more of energy constraints, user demands, user capabilities, network coverage and other parameters.

10. Devices Using a Group Member when the Device Also has Access to Services, e.g., Available (e.g., Limited) Bandwidth

If the (additional or substituting) indirect connection provides an improved or better connectivity (according to some criterion/criteria), then yes.

End of/Exit from the Group
1. Events/Decisions that End a Group

The group can be dissolved when, for example, the number of (remaining) group members falls below the required number of members, the fitness of group members falls below a given threshold, the fitness of the group members exceeds a given threshold (e.g. end of OOC for everyone), battery levels are recharged.

2. Events/Decisions Causing a Member to Leave a Group that Remains after it has Left

UEs may leave the group, for example, by: responding to a NW instruction to leave the group; a (human) user self-initiated exit; a UE might initiate an automatic request to leave the group when its capabilities fall below a defined threshold (a requirement of being a fit group member); a UE might initiate an automatic request to leave the group when its capabilities and the capabilities of other group members exceed a defined threshold (a number of fit and unfit group members remain in the group).

Whilst having described the concept of a group, embodiments also relate to a concept referred to as group of groups in which a set of groups may form a higher-layer group.

### Group of Groups (GOG)

A group of groups is comprised of two or more interconnected groups.

Groups may connect to other groups by an interconnection between at least one member of each of the groups to be interconnected.

Requirements of a group joining with another group may comprise, from each group's perspective, a consideration about a “headroom” (in terms of resource-fullness) to accept new members.

The size of the group and/or the group-of-groups may be decided, for example, according to certain optimization criteria: number of hops; critical path connectivity; protocol overhead; energy consumption.

The GOG may be managed or controlled or adjusted. For example, each group forming the GOG may manage itself according to the principles described above.

Forming a group-of-groups may provide the advantage of an even further increase of one or more of: link resilience; flexibility; capacity; reliability; reduction of latency; resource sharing (see above).

Groups may disconnect from other groups. For example, each group forming the GOG may manage itself according to the principles described above. A NWE can also issue instructions to a given group for it to: leave the GOG and/or to dismantle its own group. Groups may also decide to leave the GOG when they perceive themselves to be fitter than the GOG or suitably self-sufficient (see above).

Group-of-groups may be identified, for example, using one or more of the two methods: Identifiers may be used for individual groups and for a group-of-groups. Alternatively or in addition the GOG does not have an identifier, only the identifier of the original group is used.

The identity of a group may change when it becomes a member of a GOG but it is not required to change.

For a group of devices as well as for a GOG, one or more of the following may be considered:

Emergency (reserve) battery features
User-activated
Network-assisted
Database-directed
Triggered by:
   Network (including: cellular; NTN; any network such as Wi-Fi, Li-Fi, IoT, LoRa)
   Event (battery monitoring, location awareness)
   Geolocation, orientation

More details relating to the second aspect are described in connection with the above referenced figures.

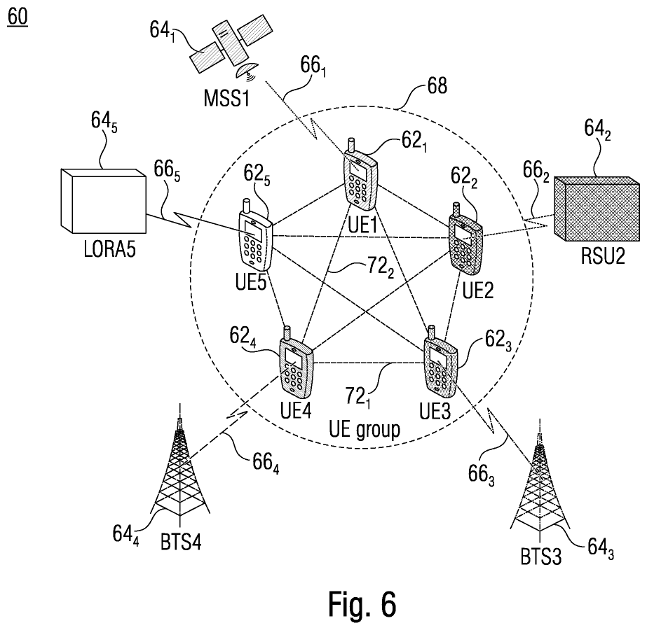

FIG. 6 shows a schematic block diagram of a wireless communication scenario 60 according to an embodiment. For example, a plurality of at least two devices, e.g., at least 3, 4, 5 or more devices such as devices 62₁, 62₂, 62₃, 62₄, 62₅ may each be associated with or adapted for a communication with an infrastructure device 64₁, 64₂, 64₃, 64₄, 64₅ respectively, e.g., a satellite as device 64₁, a roadside unit, RSU, as a device 64₂, a base station BTS as device 64₃ and 64₄ or a long-range radio unit, LORA, as device 64₅. A respective link, 66₁, 66₂, 66₃, 66₄ and 66₅ may be an unidirectional link or a bidirectional link e.g., allowing for uplink and/or downlink whilst each of the links 66₁ to 66₅ may be implemented independently from other links.

Devices 62₁ to 62₅ may be devices in accordance with a UE, a base station and/or a IoT device of FIG. 1 and/or may be implemented in accordance with device 12. Devices 62₁ to 62₅ may form a group 68 according to an embodiment. The devices 62₁ to 62₅ may be located so that by use of a specific RAT, e.g., a sidelink, Bluetooth, a local area network or the like, each of the devices may reach each other device over a respective link 72, wherein between different devices and/or to or from different devices, a same radio access technology or different radio access technology is maybe used for implementing a device-to-device or a member-to-member link 72.

In one instance of time, each of the devices 62₁ to 62₅ may communicate with the associated network entity NWE 64₁ to 64₅. In other instances of time, when, e.g., one of devices 62₁ to 62₅ loses its connection 66₁ to 66₅, such a loss may be compensated via group 68. As an alternative or in addition, a loss is not required for obtaining all the advantageous described herein. For example, one of the devices such as UE 62₁ may face a low amount of remaining energy and may receive assistance by at least one of the remaining 62₂ to 62₅ by communicating at least a part of the communication via those devices. This may comprise to provide suitable information indicating an association of the devices 62₂ to 62₅ with the group and directly or indirectly to the network comprising network entity 64₁ to route the respective communication, e.g., to a different MNO. Thus, although being not associated with the network operator of network entity 64₁, 62₂ to 62₅ may receive communication services.

In other words, a user equipment, UE, group 68 comprised of UE1, UE2, UE3, UE4, UE5 is shown in FIG. 6. Each UE 62 is associated with a network entity, NWE, 64₁ to 64₅ namely, a mobile satellite station MSS1, a road-side unit RSU2, a first base station BTS3, a second base station BTS4 and long-range radio unit LORA5. Subject to coverage and availability, UEs and NWEs being associated with each other have the possibility to form a direct wireless connection 66₁ to 66₅. Regardless of coverage and availability, it is not possible for UEs and NWEs of different networks to form a direct connection, e.g., UE 62₂ is unable to communicate with network entity 64₃ or 64₄. However, as the UEs form group 68 and are wirelessly interconnected using links 72, an indirect connection, i.e., a multi-hop connection, between UEs and unassociated NWEs is possible.

Links 72₁ and 72₂ are shown with dashed lines showing the possibility to communicate between the devices whilst, as they are able to communicate with their NWEs, they may also decide to have a direct connection with their respective network entity.

Referring now to FIG. 7, there is shown a condition of wireless communication scenario 60 having two direct connections established, link 66₁ and a link 72₃ between UEs 62₁ and 62₂, i.e., one link 66₁ between MSS1 and UE1, the other link 72₃ between UE1 and UE2. For example, a downlink multi-hop connection can therefore be made from MSS1 to UE2 whilst, optionally, additional hops may be implemented although possibly not necessarily as UE 62₁ may reach each other UE of group 68.

In FIG. 8 there is shown a situation of wireless communication scenario 60 where four direct links 72₃, 72₄, 72₅ and 72₆ are established between UE 62₁ and each other UE of group 68. Thereby, UE 62₁ may operate as a relay for the other UEs to external networks and/or for inter-group communication. That is, five direct connections have been established, one between MSS1, and UE1, link 66₁, the others between UE1 and the other four UEs. A downlink multi-hop connection can therefore be made from MSS1 to one or more of {UE2, UE3, UE4, UE5}.

In FIG. 9, there is shown a situation of wireless communication scenario 60 where a number of direct connections have been established between the UEs and their associated NWEs. However, although there is no direct connection between UE2/62₂ and network entity 64₂, i.e., RSU2, UE2 is the capital of making a multi-hop uplink connection via the other UEs to one or more NWEs using one or more of links 72₃, 72₇, 72₈ and 72₉.

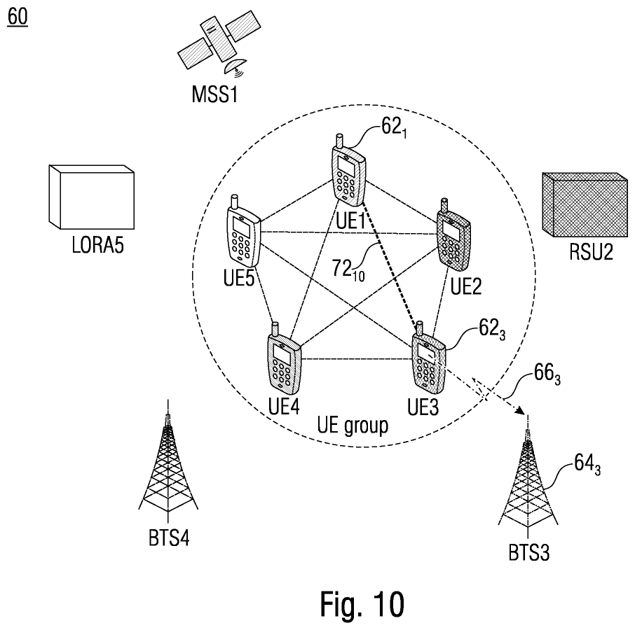

FIG. 10 shows a schematic illustration of a situation of wireless communication scenario 60 where two direct connections have been established, link 66₃ between UE3 and the corresponding network entity BTS3 and a direct link 72₁₀ between UE3 and UE1 an uplink multi-hop connection and/or downlink multi-hop connection can therefore be made from UE1 to BTS3.

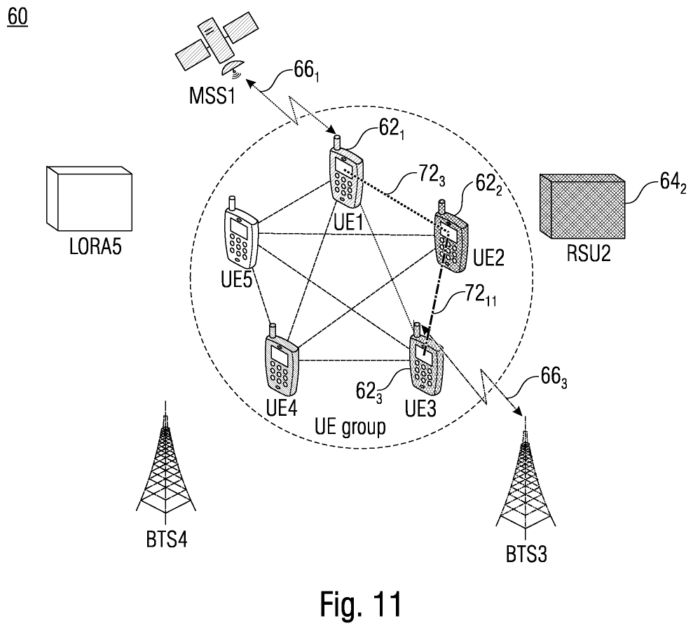

FIG. 11 shows a schematic illustration of a situation of wireless communication scenario 60 where direction connections have been established between MSS1 and UE1 between UE1 and UE2, between UE2 and UE3 using a link 72₁₁ and between UE3 and BTS3. Although UE2 does not have a direct connection to its associated NWE 64₂, it is able to establish bidirectional multi-hop connections with MSS1 and BTS3 via UE1 and UE3, respectively. Connections with more than one NWE can be used for aggregation, redundancy or splitting for parallelism or network coding.

For example, one or more of the following considerations may apply:
UE capabilities may be configured according to a geographical map of connection opportunities. This may result in:
   e.g. regions of good coverage, reasonable coverage, partial coverage, inadequate coverage and no-coverage, i.e., different levels of coverage
   e.g. regions supporting emergency functions/services (subject to activation) such as voice services, message services, data services
UE capabilities may be configured to preserve a certain amount such as X % of the UEs total battery capacity for emergency functions/services only. Such configuration may be initiated by, e.g., a user that may know its further duration of travel or the future route or the like, but may also be initiated, at least in parts, by the network
The UE group may be a set of UEs that have direct/indirect connectivity to other UEs in the same UE group.
The UE group may allow indirect connectivity to a network entity where/when direct connection is not possible due to factors that are not limited to include: subscription privileges; RAT support; capabilities; and coverage/range.
Indirect connection maybe understood as a form or type of relaying within the UE group.
Relaying can be:
   see examples presented in FIGS. 7-11
   with/without store-and-forwarding
      forwarding to a NWE is subject to:
         earliest availability
         priority
         selection
         aggregation for redundancy
         splitting for parallelism or network coding

If UE1 is OOC but indirectly connected to the Internet via UE2, then UE1 informs CN1 via the Internet/UE2 that paging messages for UE1 should be rerouted via CN2 to UE2. This may not relate to a simple call forwarding and requests to build a tunnel to UE1.

UE1 can inform CN1 about multiple paging options (e.g. to be ordered, prioritized, scheduled, etc.)

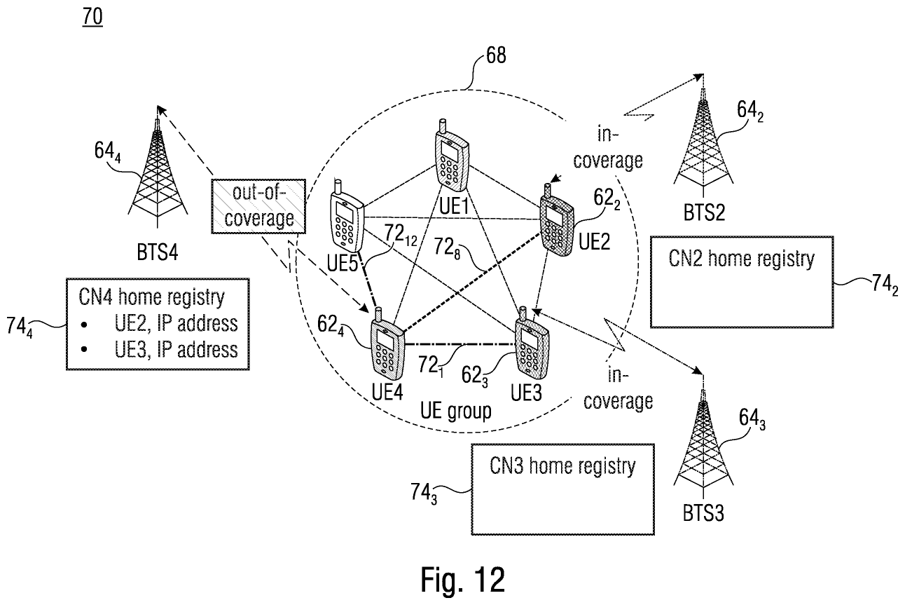

FIG. 12 shows a schematic illustration of a scenario of group 68, e.g., the same group shown in connection with wireless communication scenario 60, but in a different scenario 70 where UE2 and UE3 are within coverage of their respective network entities 64₂, 64₃, respectively. Even though UE4 may be out-of-coverage, OOC, with its associated NWE 64₄, it can still form a multi-hop connection, e.g., to the internet, via UE2 and the network entity 64₂ and/or UE3 and its network entity 64₃. UE4 can therefore inform its core network CN4, 74₄, that it is OOC. Additional or other information may also be transported. The home registry of CN4 can thus be provided with a prioritized routing list of the IP address associated with UE2 and UE3. This allows paging messages to reach UE4 via either BTS2 and UE2 or via BTS3 and UE3 or a combination. Subsequent tunnels can then be built to connect UE4 via the other UEs and NWEs.

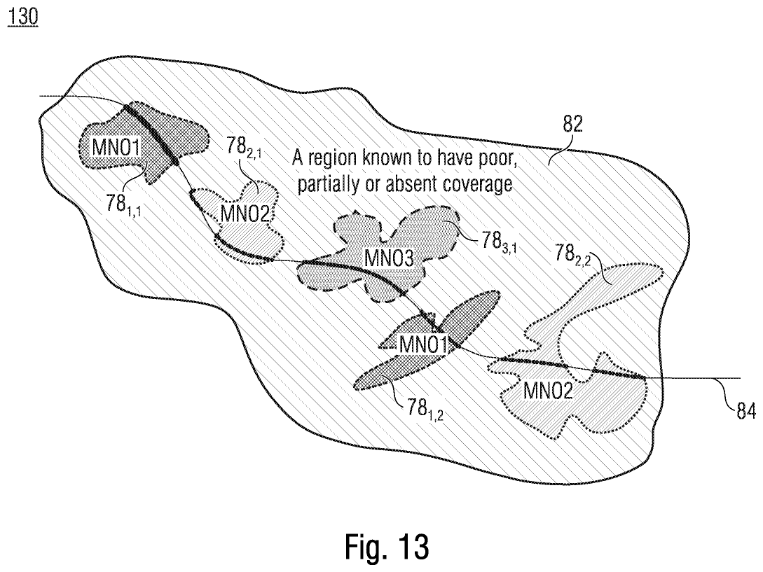

FIG. 13 shows a schematic top view of a geographical area 130 where different coverage areas 78_{i,j} are located, wherein i relates to an MNO; and j optionally differentiates between different areas of a same MNO. Between the different coverage areas 78_{i,j} one or more regions 82 are arranged that provide poor, partially none or no coverage. With reference to group 68, the group traveling along a path 84, it may be seen that at different locations along path 84 different members of the group may relay communication or may provide communication service for other members upon being in coverage of their MNO whilst other members become OOC. At region 82, for example, a non-terrestrial network may be used to provide communication for the group.

In other words, FIG. 13 shows a geographical region 130 in which cellular network coverage is known to be poor or partially might also be thought of as a region in which no coverage is provided at all, see area 82. However, careful direct mapping of the area or a construction of a coverage map resulting from signal and location data collected by UEs in the area reveals that some areas of patchy coverage is associated with specific MNOs, areas 78_{i,j}. A user's UE can therefore be configured to activate certain functions in the areas 78_{i,j} and to deactivate functions in area 82.

Embodiments according to the second aspect may be combined with embodiments according to the first aspect without any limitations. A group-assisted communication may benefit from an a priori knowledge about a reception and/or transmission opportunity to even further enhance the assisted or helped communication.

Embodiments according to the first aspect may be combined with embodiments according to the second aspects without any limitations. An a priori knowledge about communication opportunities may be used to assist communication of a different member of a group, e.g., to even further save resources or to provide for at least a minimum of communication.

### Third Aspect

According to a third aspect, embodiments relate to message forwarding with extensions. Such embodiments may be advantageously used in wireless communication networks but may also be used in wired and/or optical networks including electrical networks used for electrical energy generation, transmission, distribution and storage for example, an electrical power grid used for connecting energy producers, energy consumers and/or energy storers with and or without the transformation of the electrical power.

The inventors have identified a problem in known systems as follows. Consider a communication network comprised of a plurality of network entities and in which a first device or network entity wishes to send a message to a second device or network entity. The network is thus used by a sender to send a message to a recipient using a route which might involve intermediate network entities in between the source and destination network entities or nodes. Indeed, at the time of sending the message, the route taken might be unknown (as is often the case) as this depends on the availability and condition of the inter-node routes within the network which in turn can change as the network routes messages or datagrams between other source-to-destination connections.

The location of the sender within the network can be identified by its source address and that of the recipient by its destination address. For the sender to know that the message has been received by the intended recipient, it is common in state-of-the art systems for an acknowledgement to be sent by the recipient to the sender. In other words, when the message has been received at the destination address, an acknowledgement (ACK) or some other kind of notification or feedback is sent through the network to the source address. At the time of sending the acknowledgment, the route that will be taken is generally unknown.

It is now clear that since the route taken to transport a message through the network in the forward direction (i.e., from the source address to the destination address and possibly using additional intermediate nodes) is dependent on the design, usage and current condition of the network, that the time needed for a message to be sent from the source to the recipient can vary. When the message arrives at its destination and an ACK is sent in the return direction (i.e., from the destination address to the source address), the time needed for its delivery can also vary. Now since the forward and return routes may comprise the same or a different set of intermediate nodes, the delivery times in both directions not only depends on the current condition of the network but also the route taken. Therefore, it is not possible to both accurately and precisely determine the time it will take for a message to be forwarded nor for an acknowledgment to be returned.

In known or state-of-the-art systems, a time-out function can be used to reduce the uncertainty created by waiting indefinitely for an acknowledgement. For example, when a message is sent from and by the first device, it starts a timer with the expectation that an acknowledgment is returned to it by the second device within a defined period. If the return is not received within this period, the first entity can then execute a function in the absence of the acknowledgement.

For time sensitive systems—for example, mission critical communications—the first entity's ability to make a local decision before a timeout occurs would allow it to change its strategy and adapt to the current network conditions. To this end, some form of enroute or internodal feedback would provide the first entity with additional information. It is however the inventors' current understanding that such feedback is not state-of-the-art. A solution to this is therefore disclosed herein.

### Standardization

An example of a standardized state-of-the-art communication protocol, primarily used for non-wireless purposes, is presented in this section. Whilst this example is generally used for wired communications, it is included here to illustrate the structure and format of a so-called data packet or datagram since, as will be disclosed later, the invention finds benefit in various types of networks including those which are wired and those which are wireless.

### Transmission Control Protocol/Internet Protocol (TCP/IP)

The Transmission Control Protocol/Internet Protocol (TCP/IP) is a suite of communication protocols that is standardized by the Internet Engineering Taskforce (IETF). TCP/IP was developed in the 1970s and has since become the standard protocol for internet communications. In general terms, it allows digital computers to communicate over networks, including the internet.

The TCP/IP suite consists of multiple protocols that work together to enable reliable and efficient data transmission. Some of the key protocols within TCP/IP include:
TCP (Transmission Control Protocol): TCP provides reliable, connection-oriented communication between hosts. It ensures that data packets are delivered in the correct order and without errors. TCP handles flow control, congestion control, and error recovery.
IP (Internet Protocol): IP is responsible for addressing and routing packets across networks. It defines the format of IP addresses and ensures that packets are delivered to the correct destination. IP is a connectionless protocol, meaning it does not establish a direct connection between sender and receiver.
TCP/IP also includes other protocols such as User Datagram Protocol (UDP) for connectionless, lightweight communication, and Internet Control Message Protocol (ICMP) for error reporting and diagnostic messages.

The standardized nature of TCP/IP allows different devices and networks to communicate with each other seamlessly. It is widely implemented and supported across various operating systems and network devices.

### Format of UDP Packets

UDP (User Datagram Protocol) is a connectionless protocol that operates at the transport layer of the TCP/IP protocol suite. UDP packets have a simple format that consists of a header and a payload. The format of a UDP packet is described as follows:
Source Port: A 16-bit field that specifies the port number of the sender.
Destination Port: A 16-bit field that specifies the port number of the receiver.
Length: A 16-bit field that indicates the length of the UDP packet (header+payload) in bytes.
Checksum: A 16-bit field that provides error detection for the UDP packet.
Payload: The actual data being transmitted.

Unlike TCP, UDP does not have mechanisms for flow control, error recovery, or congestion control. It is a lightweight protocol that prioritizes speed over reliability.

### Format of TCP Packets

TCP (Transmission Control Protocol) is a connection-oriented protocol that provides reliable, ordered, and error-checked delivery of data between applications. TCP packets have a more complex format compared to UDP. The format of a TCP packet is described as follows:
Source Port: A 16-bit field that specifies the port number of the sender.
Destination Port: A 16-bit field that specifies the port number of the receiver.
   Sequence Number: A 32-bit field that identifies the position of the data in the stream.
   Acknowledgment Number: A 32-bit field that acknowledges the receipt of data.
   Data Offset: A 4-bit field that specifies the length of the TCP header in 32-bit words.
   Flags: A set of 6 control flags, including SYN, ACK, FIN, RST, PSH, and URG.
   Window Size: A 16-bit field that indicates the size of the receive window.
   Checksum: A 16-bit field that provides error detection for the TCP packet.
   Urgent Pointer: A 16-bit field that indicates the end of urgent data.
   Options: An optional field that can include additional TCP options.
   Payload: The actual data being transmitted.

TCP ensures reliable data delivery by using mechanisms such as sequence numbers, acknowledgments, and retransmissions. It also provides flow control and congestion control to optimize the transmission of data.

### Format of IP Packets

IP (Internet Protocol) is a network layer protocol responsible for addressing and routing packets across networks. IP packets encapsulate the transport layer protocols like UDP and TCP. The format of an IP packet is described as follows:
Version: A 4-bit field that indicates the IP version (IPv4 or IPv6).
Header Length: A 4-bit field that specifies the length of the IP header in 32-bit words.
Type of Service: An 8-bit field that provides information about the quality of service.
Total Length: A 16-bit field that indicates the total length of the IP packet (header+payload) in bytes.
Identification: A 16-bit field that helps in reassembling fragmented IP packets.
Flags: A set of 3 control flags, including DF (Don't Fragment), MF (More Fragments), and Fragment Offset.
Time to Live: An 8-bit field that limits the lifetime of the IP packet.
Protocol: An 8-bit field that specifies the transport layer protocol (e.g., UDP or TCP).
Header Checksum: A 16-bit field that provides error detection for the IP header.
Source IP Address: A 32-bit field that identifies the sender's IP address.
Destination IP Address: A 32-bit field that identifies the receiver's IP address.
Options: An optional field that can include additional IP options.
Payload: The encapsulated transport layer packet (e.g., UDP or TCP).

IP is responsible for routing packets across networks based on the source and destination IP addresses. It provides a best-effort delivery service, meaning it does not guarantee reliable delivery or ensure packet ordering.

It's important to note that the format of these packets may vary slightly depending on the specific protocol versions and options being used.

### Research Literature

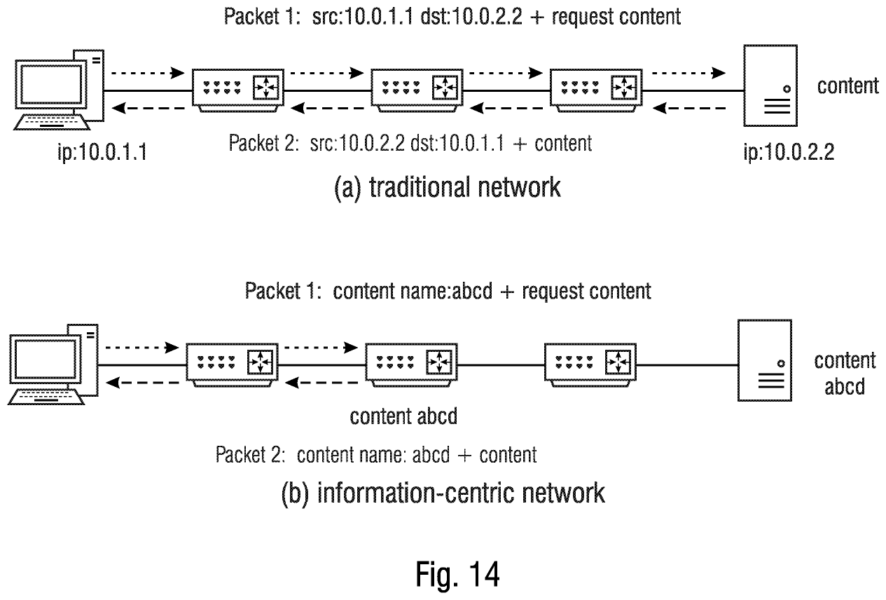

FIG. 14 showing a known communication concept, compares the message transport concept used in a traditional network with that used in an information centric network (ICN) [Fehler! Verweisquelle konnte nicht gefunden werden.]. In the ICN, a query or request for specific content—described by for example, keywords—is sent to the network or a specific network address. When the request is received at the latter: the query is parsed by a server; a new target address is retrieved from a content-cum-location database; the new address is added to the content; and the packet is forwarded to the new address. Subsequently, at the server of the new address, the message is parsed and the content requested by the query is then returned to the address from which the query originated, i.e., the source address.

This ICN approach is different to the technical solution herein as follows:
The purpose of the invention is to send a message to a known target address or to an approximate address which is well described either by the message itself or by its extensions.
The purpose of sending the message to the target address is to obtain a response matching the message. Examples are not limited to include; asking for help; sending a control command to a machine which executes the command and provides confirmation after execution; or the message has an informative purpose where the response is limited to an acknowledgment (ACK). In ICN the query (message) is responded with a matching information content-consider for example, a Google keyword search.
In the ICN approach and for the case of the target address being known directly or explicitly with respect to the appropriate target (a target that can respond to the message in the given context), the second node knows from where to retrieve the requested content or knows the address of the server that knows where to find it. In the invention disclosed herein however, the second node has primary routing knowledge that allows the message to be forwarded towards the target destination, without knowing that the latter can respond to the message.
In contrast to the ICN approach and for the case of the target address being known indirectly or implicitly with respect to the appropriate target (a target that can respond to the message in the given context), the second node can parse the content of the message and/or its extensions and can derive from one or both a suitable next node address and thus an estimate of the target destination. In comparison to the ICN approach described above, in the invention described herein, the second node estimates an appropriate target destination to which the message will be forwarded.

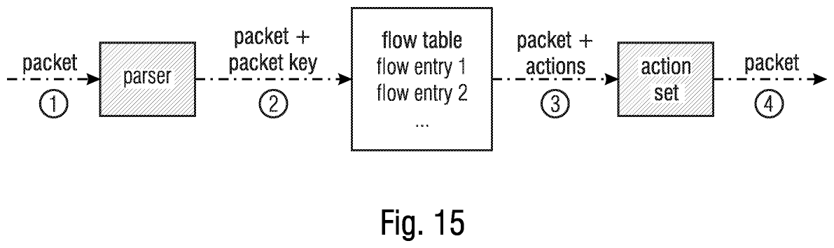

FIG. 14 shows communication characteristics in different networks according to [Yang_2021] and FIG. 15 shows the main packet processing in programmable forwarding devices according to [Yang_2021].

To address the problem described above in connection with the third aspect, some of the embodiments related to the third aspect disclosed herein propose to use message forwarding with extensions and, in particular, with extensions that can be modified during the transport of the datagram or packet from node to node through the network. Prior to discussing this in detail, a few preliminaries are presented first.

### Network Topologies

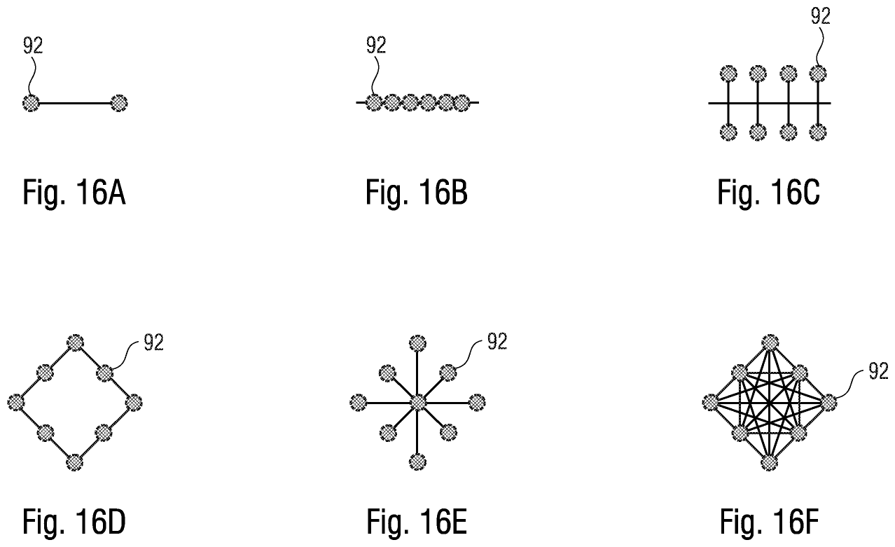

The way in which the entities or nodes that comprise a network are arranged is referred to as the network topology. FIG. 16 presents examples of different network topologies including a hybrid topology resulting from the combination of other network types. The entities or nodes that form the network can be of the same or different type and hence might have different capabilities and support different technologies.

Node: A node may be understood as a device that is connected to a network. For this explanation, a node is the same as a network entity not limited to include for example, a basestation, a user equipment, a repeater, a relay, a reconfigurable intelligent surface, a transmission and reception point, an access point, a user terminal, a wireless router. Network topology deals with how the nodes of a network are connected to each other.

FIG. 16 shows schematic illustrations of simplified network topologies. In FIG. 16a, there is shown an end-to-end or point-to-point topology between two communicating devices 92. In FIG. 16b, there is shown a linear or series topology of devices 92. In FIG. 16c, there is shown a bus-like or common-bus topology of devices 92. In FIG. 16d, there is shown a ring topology of devices 92. In FIG. 16e, there is shown a star topology of a communication between devices 92. In FIG. 16f, there is shown a fully connected topology of devices 92. In FIG. 16g, there is shown a mesh topology of communicating devices 92. In FIG. 16h, there is shown a tree topology of communicating devices 92 and in FIG. 16i, there is shown a hybrid topology of communicating devices 92.

### The Datagram or Packet

It is important to recognize that the message transported through the network is comprised of at least two parts: content and extensions. The former of these—the content or payload—is the message per se: for example, “Zone_4:Sensor_B:Temperature_55:Units_celsius” whereas the latter—the extensions—contains for example: identification details, address information, location, priority, timeout, validity and billing data (a further discussion of these extensions is presented below) but not excluding parts like address or the like. The payload can be likened to user-plane content whereas the extensions can be thought of as control-plane data.

Packet: A packet is a message that is sent over the network from one node to another node. The packet includes at least a set of addresses and data. The address information includes the address of the node that first sent the packet (the source address), the address of the node the packet is being sent to (the destination address) and may also include the address of the node that last sent the packet (the intermediate address).

A Datagram with Extensions

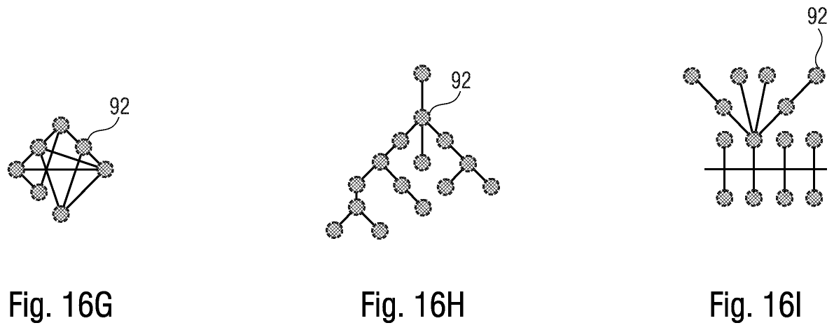

FIG. 17 shows a schematic block diagram of a data packet 140 according to an embodiment comprising a plurality of data blocks, at least a header block 94, a message payload block 95, a payload CRC block 96 and an extension block 97, wherein FIG. 17 also shows an optional reserved block 98. Whilst the message payload 95 may carry payload data, the payload cyclic-redundancy-check, CRC, 96 may comprise redundancy information.

An example of a data packet is presented in FIG. 17. This contains, by way of example: a header block; a message payload; a cyclic-redundancy-check checksum relating to the payload; an extension block and; a reserved block.

### The Header Block

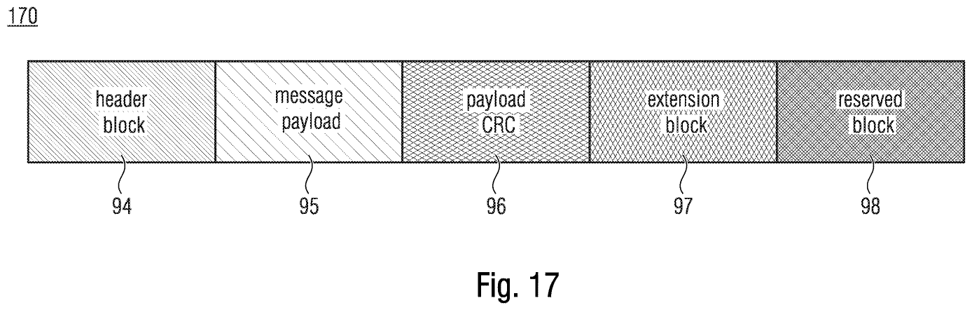

An example of the content of the header block is shown in FIG. 18. This contains, by way of example: a packet identification (ID) block; a cyclic-redundancy-check checksum relating to the header block; an address block and; a block containing options (for example information relating to: security; classification; routing inclusion list; and routing exclusion list).

FIG. 18 shows a schematic block diagram for illustrating a possible structure of the header block 94, wherein packets 94A, 94B, 94C and 94D may be arranged in any different order when compared to the illustrated one. The header block 94 may comprise, according to an embodiment, a packet ID block 94A, a header CRC block 94B, an address block 94C and an optional options block 94D.

### The Address Block

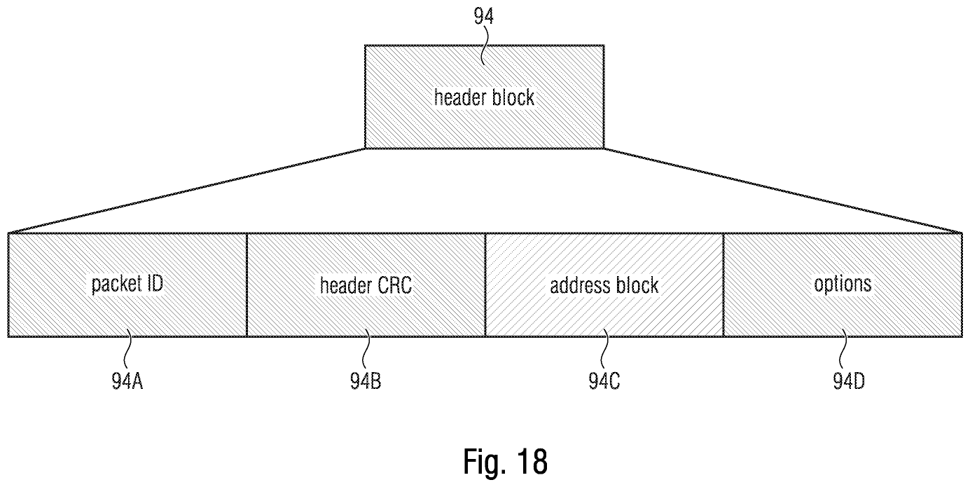

An example of the content of the address block is shown in FIG. 19. This contains, by way of example: a source address; a destination address; a temporary address which can be used as an intermediatory address and; a cyclic-redundancy-check checksum relating to the address block.

The source, temporary and destination addresses can use direct or indirect addressing methods.

Direct addressing: In direct addressing mode, the source/destination/temporary address field in the address block contains the effective address such as: an IP address; an IMSEI address; or a MAC address.

Indirect addressing: In indirect addressing mode, the source/destination/temporary address field in the address block contains the location or address of where the effective address is held such as: a uniform resource locator (URL); or a mobile telephone number.

FIG. 19 shows an example of an arrangement of addresses within an address block 94C. Example sub-blocks of address block 94C may comprise a source address 94C-A, a destination address 94C-B, a temporary address 94C-D as well as an address CRC 94C-D which is, however, optional. As described for other illustrations hereof, a sequence of blocks may be changed when compared to the illustrated ones.

### The Extension Block

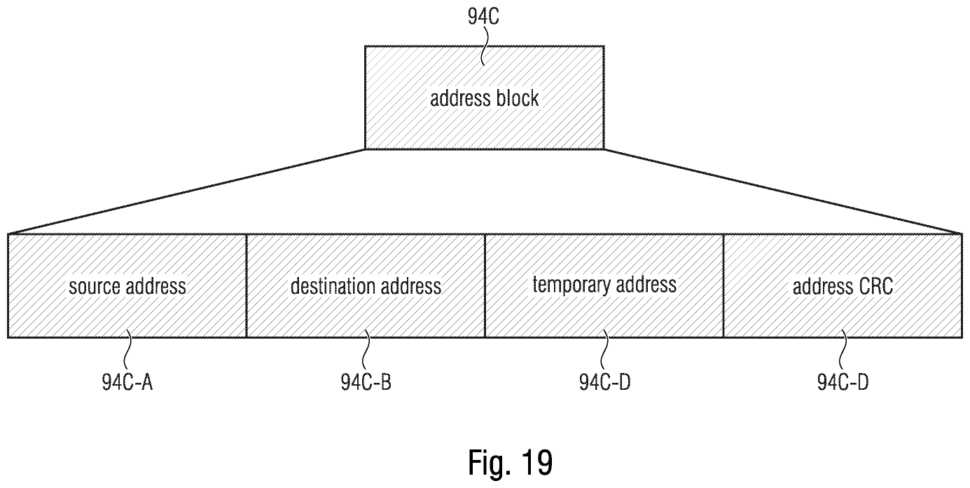

An example of the content of the extension block is shown in FIG. 20. This contains, by way of example: a priority block (wherein priority is used to signal the relative importance and/or precedence of data and can be used to decide which data to process first, or how to resolve contention for access to shared resources in line with user requirements both within and between applications); a repetitions block (in which, for example, the maximum number of delivery attempts to be made before quitting is specified); an acknowledgement (ACK) class (the ACK class can, for example, include “no acknowledgement”, “simple acknowledgement”, “acknowledgment with time stamp”, “acknowledgment with response” or double acknowledgment; an expiry block (which can for example provide a validity or “shelf-life” for the message; a delivery time block (for example information relating to: before when or after when the message should be delivered). According to embodiments, the Extension block may comprise parts or all of the header block and/or the reserved block.

FIG. 20 shows a schematic block diagram of an example structure of the extension block 97 comprising at least a subset and in any order a priority block 97A, a repetitions block 97B, an ACK class block 97C, an expiry block 97D and a delivery time 97E. Those blocks may contain important information with regard to the message forwarding, wherein, for example, an expiry information contained in expiry block 97D may relate to a time or a number of hops that the message may be forwarded. Further, for example, a delivery time indicated in delivery time block 97E may indicate by when the message is expected to be received or delivered to the recipient, thereby allowing local prioritization.

### The Reserved Block

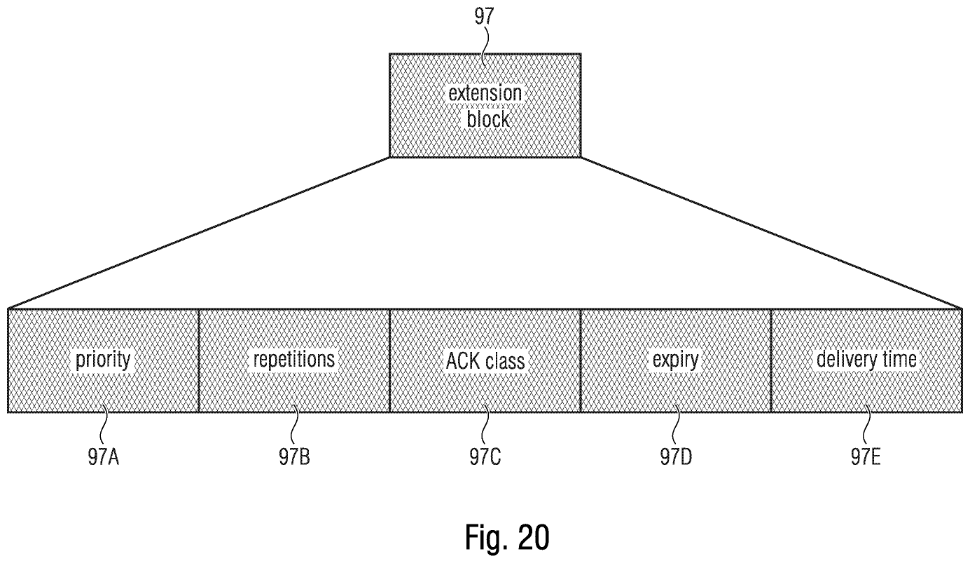

FIG. 21 shows an example of a reserved block which itself can, for example, be comprised of a number of optional blocks reserved for further options.

FIG. 21 shows a schematic block diagram of a possible structure of reserved block 98 that may comprise one or more optional options block 98A to 98N to indicate options applying for the message, i.e., FIG. 21 shows an example of the arrangement of optional fields within a reserved block.

### Raw Extensions and Refined Extensions

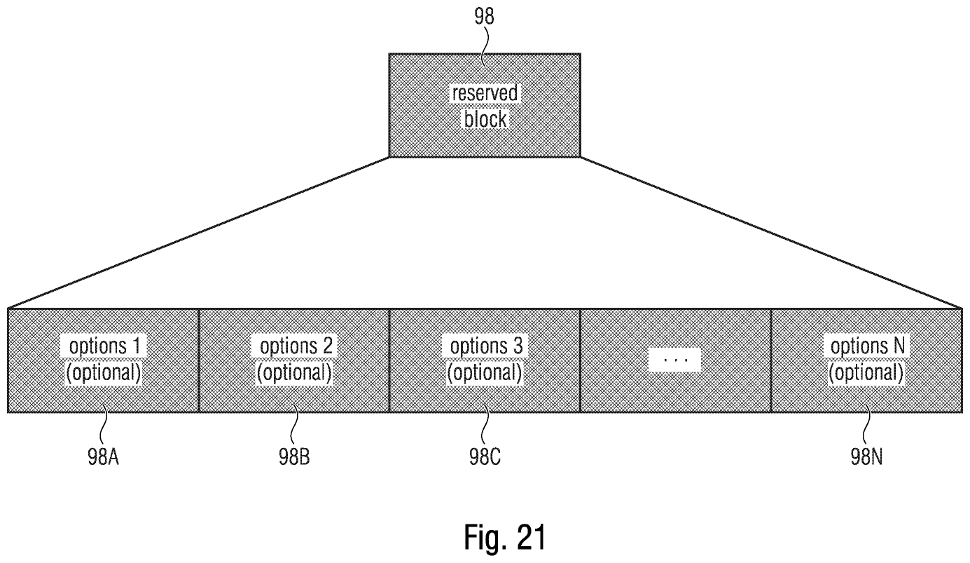

With reference to FIG. 17, the datagram or message packet is redrawn in FIG. 22 to show a block containing raw extensions which can, for example, represent the status of the extensions when the datagram is released from the source address into the network. At this stage of its journey through the network, some of the fields that comprise the extension might be set to a default condition, remain empty or carry an indicator that labels their state as undefined.

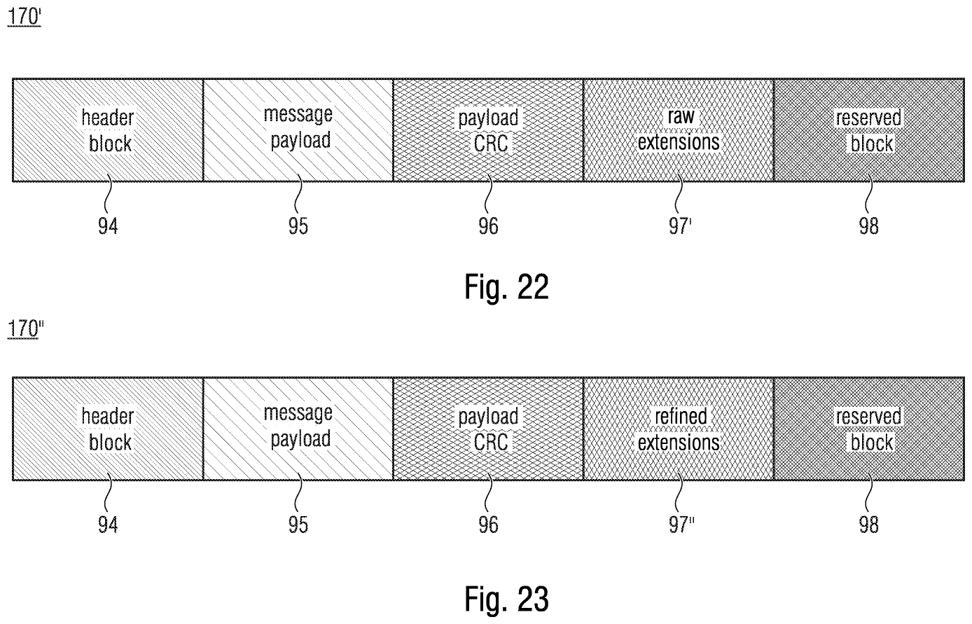

As the datagram is transported through the network and is routed from node to node, the experience of the packet along each node-to-node path within the overall the source-to-destination route can be recorded or updated in the extension block. Furthermore, the content of the extension block can be processed enroute by network nodes in order to, for example, provide a route according to one or more criteria such as, for example, a priority, a security, a delivery time, a message size and an expected outcome. In this sense, the extensions are said to be refined as is shown in FIG. 23.

In other words, FIG. 22 shows a schematic block diagram of a block arrangement of a message 170′ that may be compared to message 170 but that comprises a modified extensions block labeled as raw extensions in block 97′. Compared to FIG. 22, there is shown a message structure of a message 170″ that comprises, instead of raw extensions block 97′, a refined extensions block 97″. That is, FIG. 22 shows an example of a datagram or message packet comprised of various blocks including raw extensions described above and FIG. 23 shows an example of a datagram or message packet 170″ comprised of various blocks including refined extensions as described above.

### A Network of Networks

The networks discussed thus far might be comprised of a plurality of networks of the same or different type including for example: wireless, wired and optical networks; wireless networks of different radio access technologies (3G UMTS, 4G LTE, 5G NR, Wi-Fi, LoRaWAN, Bluetooth, QuickLink, etc.); terrestrial and non-terrestrial networks; infrastructure-based networks; non-infrastructure-based networks; and hybrid combinations thereof. Therefore, when the user-plane and control-plane parts pass through different network segments (including network resource owners and countries), a partial modification of the user-plane and control-plane parts can be derived from the latest transportation experience. Even before the datagram is delivered to the destination, the information contained in the updated user-plane and control-plane parts can be used within the various segments of the overall network for the benefit of the segment and network alike. Similarly, preliminary feedback can also be returned to the source in advance of the ultimately enriched acknowledgment being sent from the destination to the source. Depending on the content of the preliminary return, the sender can adapt its communication strategies according to current network condition or might even be able to derive useful information from the enhancement even though the original message was not delivered by the recipient. Preliminary feedback messages can thus be classified as form of message forwarding with extensions wherein the extensions can be modified on a node-to-node basis. This offers not only direct benefit to all the network entities used in a particular communication or information transportation but also to the network in general.

### End-to-End Packet Delivery

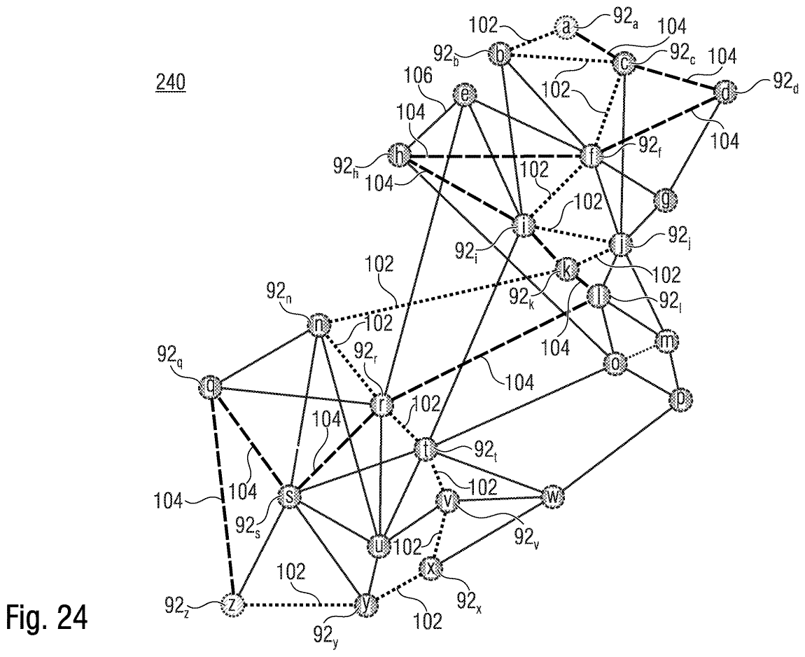

A network comprised of the entities or nodes labelled ‘a’ to ‘z’ relating to respective nodes 92 is shown in FIG. 24 wherein the source node is ‘a’, 92ₐ respectively and the destination node is ‘z’, 92_{z} respectively. A datagram may be sent from the source node ‘a’, via the forward paths 102, to the destination node ‘z’. According to embodiments, at least one of an acknowledgment, a response or a reply may sent from the destination node ‘z’, via the reverse paths 104, to the source node ‘a’.

In this example, the forward route follows the path between the nodes a-b-c-f-i-j-k-n-r-t-v-x-y-z whereas the return route follows a different path between the nodes z-q-s-r-l-k-i-h-f-d-c-a. This does not exclude the same route being followed by both forward and return paths. In FIG. 24, other inter-node connections or paths 106 which do not form any of the routes in the example, may nevertheless be used.

In other words, FIG. 24 shows an example of routing paths within a network comprised of network nodes or entities ‘a’ to ‘z’. The source node may be node ‘a’ and the destination node may be node ‘z’. The forward and reverse paths 102 and 104 are shown as well as other inter-node connections 106 are depicted by. The forward route follows the path between the nodes a-b-c-f-i-j-k-n-r-t-v-x-y-z whereas the return route follows a different path between the nodes z-q-s-r-l-k-i-h-f-d-c-a.

Such a delivery may be supported by the message structure shown herein.

### Non-End-to-End Packet Delivery

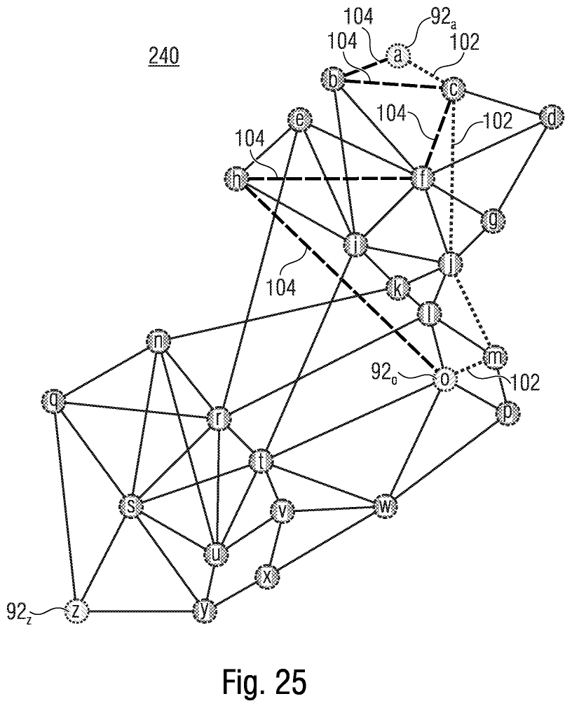

A packet is to be sent from a first device to a second device wherein both devices are interconnected through one or more networks. With reference to the network shown in FIG. 25, the first device is either connected to or is itself the first node of the network (node ‘a’) and the second device is either connected to or is itself the last node of the network (node ‘z’). In between the first and last network nodes, several other network nodes might exist—in this case, nodes ‘b’ to ‘y’.

Packets as described herein may be routed through the network 240 from one node to another node. When sending the packet from the first network node 92ₐ, it might not be known how many nodes are between it and the last network node 92_{z}. Regardless of this, in the forward path the packet is transported from the first node to a second node, from the second node to a third node, and so on until the packet is finally sent from the penultimate node to the last node.

In other words, FIG. 25 shows an example of routing paths within a wireless comprised of network nodes or entities ‘a’ to ‘z’ similar to FIG. 24. The source node ‘a’, i.e., node 92ₐ and the destination node ‘z’, i.e., node 92_{z} communicate whilst the return termination node ‘o’, i.e., node 92ₒ is added. The forward and reverse paths 102, 104 are shown. Other inter-node connections 106 are depicted. The forward route follows the path between the nodes a-c-j-m-o whereas the return route follows a different path between the nodes o-h-f-c-b-a.

An acknowledgement may sent in the return path being the same or a different path and from the last node to the first node and might involve several nodes in between. The forward and return paths might use the same or different intermediate nodes and might therefore use a same or different number of intermediate nodes and therefore the same or different routes. An acknowledgement can also be sent from one or more intermediate nodes.

In the forward path:
1. The packet is to be sent from a first node of the network to a second node. The packet contains a message and extensions. The extensions might contain full or partial information related to the packet, its source, destination, priority, validity and so on.
2. The packet is sent from the first node to a second node.
3. The packet is received by a second node of the network.
   The second node can be equipped with the means to interpret/process and thereafter store: the content of the payload part of the packet being forwarded; the content of other packets that were forwarded; and the content derived or interpreted from external contextual information. The second node can therefore ensure that the content of the packet is for example, refined, augmented, extended, improved and clarified.
      For example, the second node of the network has already forwarded traffic related to the detection of a fire in a certain woodland area. As it recognizes that similar information is being sent from a similar part of the woods, it can modify the content of the message so that when it is returned to the sender (for example, to inform the sender that help is on the way), appropriate actions are taken. This thus shortens the response time, reduces network load and hence improves network energy efficiency.
   The second node can be equipped with the means to assess the level of completion of the extensions by inferring from: the payload only; the extensions only; contextual information only; and any combination thereof. Using this information, the second node can process further extensions and ensure that the packet extensions are for example, refined, augmented, extended, improved and clarified.
      For example, the second node of the network is/might be equipped with the means to determine the time taken for the packet to travel (or hop) from the first node to the second node. This can be derived from timing information contained within the extension which might also be associated with a particular route. The second node can therefore ensure that the hop time and route is stored in the extensions.
   The second node can already provide feedback to the first node, even though the packet has not been delivered to the final node.
   The second node can also provide feedback to the first node regarding: any modifications of the message content or its extensions; or any information related to the forwarding from the second node to any further node.
4. The packet is sent from the second node to a third node.
5. As in 3) the packet is received by the third node of the network and its extensions and/or payload are further processed.
6. The steps 3) to 5) are repeated until the packet is received by the final node.
7. When the packet is received by the final node of the network, and as in 3), its extensions and/or payload are further processed.

In the return path:
1. The packet is to be sent from the last (now the first) node of the network to a second node. The packet can contain an acknowledgement (referring to the original message and its extensions), a return message, a response and extensions. The extensions may contain a full set of information related to the original packet and its source, destination, priority, validity and so on.
2. As before, the return packet is automatically routed through the network.
3. The content of the return packet and/or its extensions might be further processed.

The (original) final node may also request an acknowledgement to know that its acknowledgment has been received by the (original) source node. This describes a double acknowledgment mechanism wherein the acknowledgement of the acknowledgement can be a message per se or an observable action.

Processing of the message at intermediate nodes.

When the message (content+extensions) arrives at a particular node from a previous node the following processing is assumed in our method:
1. Parsing of the content part of the message before message forwarding
   a. Parsing of the content part of the message for semantic understanding. This can be done e.g. with semantic interpreters, command mapping, GPT, etc.
   b. Derive an equivalent new or modified content representation to be forwarded to the next node. Equivalence in this context means that the newly formulated content conveys sufficient information considering additional context available at the target node Z or further node along the route towards target node Z. The importance is in the fact that the response from node Z is equivalent with respect to the goal to be achieved when sending the message from the source node.
   c. The modification of the content can also include the provision of a response to the message instead or on behalf of node Z. This could be the case when the intermediate node has sufficient context and information to reply to the message with sufficient accuracy (context and intention wise). This early proxy-response along the route from node A to node Z safes routing time and resources and significantly reduces the response time.
2. Parsing of the extension part of the message before message forwarding
   a. Parsing of the extension part of the message for priorities, alternative routes, selection of the next node, timing requests etc.
   b. In case modifications of the extensions are identified to be suitable or needed, the node will derive and apply the appropriate changes (modifications, additions, reductions) in the extensions.
   c. The modified extensions should match the modified message content from point 1 above.
   d. After optional modification of the extension part the next node(s) along the route are identified

After parsing of the content and extension part of the message and potential modifications the message will be forwarded from the intermediate node to either the next node along the ongoing route forward towards node Z and/or backwards towards node A.

The intermediate node can decide or can be requested to provide status feedback towards node A or towards node Z, wherein towards includes the option to either provide explicit or implicit status information about the processing status of the message, performed modifications of the message or the like. Such status update/feedback can be piggybacked with the message or can be provide in a separate message. The meaning of “towards A or Z” shell describe the two options of informing the original sender (node A) about the status of forwarding or processing of the message and/or what happened with the message along the path towards node Z. “towards node Z” provides further node along the path between the intermediate node and node Z to be aware of the modifications made by the intermediate node or previous nodes, therefore providing additional context and/or a change track history to be evaluated (optionally) for further processing of the message in case.

Embodiments according to the third aspect allow, amongst others, the following benefits: When a user-plane message is forwarded in the network, its content can be modified by network entities through which the message is transported such that:
4. the meaning of the message can be clarified, refined or enhanced (quality improvement) and/or;
5. the message can be provided with more context, for example using transcoding or other modifications; and/or
6. the size of the message can be reduced or compressed (size reduction).

Furthermore, when a control-plane message is forwarded in the network, its extensions can be tailored for the purpose of providing enhanced control plane information such to facilitate:
7. the appropriate routing or forwarding; and/or
8. the appropriate priorities for subsequent nodes to handle the message.

The improvement of message handling such as that described above can be applied in any combination of application in the user-plane and/or the control-plane.

Each or any of the nodes can provide feedback relating to the status of the message forwarding and processing including (optionally) which modifications or additions to the extensions have been made

With reference to FIGS. 24 and 25 whilst also referring to the example datagram structures described in connection with FIGS. 17-23, according to the third aspect there are provided devices providing a forwarding functionality. A forwarding functionality may relate to but is not necessarily the same as a relaying service as a relaying service may be understood as leaving a message unchanged. However, according to embodiments described for the third aspect, the message structure, the content thereof and/or fields of a datagram may be changed by the forwarding node. The device providing the forwarding functionality along a path or path segment between a source node and a destination node, which does not require to have a direct path or a shortest path, contributes to the forwarding functionality by providing a second message responsive to a received first message. That is, the device receives the first message and generates, based on the first message, the second message. The device is configured for parsing at least a part of the message to obtain a parsing result. As described, parsing may relate to parsing of the content part of the message and/or to parsing of the extension part of the message. Parsing leads to obtain a parsing result and the device determines, based on the parsing result, a suitable recipient for the second message or a message derived thereof. That is, the device determines a localized routing of the message based on its local level of information and provides the second message towards the suitable recipient. The suitable recipient is not necessarily a device that is to be reached with the very next hop but may be a device that is located several hops away.

That is, the term providing forwarding functionality relates to distributing information towards a recipient by generating own message and/or by determining a suitable recipient for a message to be forwarded

According to an embodiment, a device for operating in a network that provides a forwarding functionality along a path or path segment between a source node and a destination node, is provided. The device is contributing to the forwarding functionality by providing a second message responsive to a received first message. The device is to: receive the first message; parse at least a part of the message, e.g., at least a part of payload and/or at least a part of extension information including address fields and the like, to obtain a parsing result. The device determines, based on the parsing result, a suitable recipient, e.g., a next hop node and/or the destination node, for the second message or a message derived thereof. That means that that the next hop recipient and/or the final recipient being possibly away more than one hop may be determined, the latter comprising that the message derived from the second message is a message generated by another node along the path. The device is to provide, e.g., transmitting, the second message towards the suitable recipient. Transmitting is not necessarily linked to wireless systems as the embodiments described herein may also be implemented in non-wireless systems such as wired and/or optical communication systems.

The suitable recipient may be one or more of: the destination node, a next hop node or a different node that is identified explicitly or implicitly as being able to assist the forwarding and/or to answer the message of the source node or an earlier forwarding node and/or suitable for providing a service or information requested, directly or indirectly, by the message sent by the source node. The suitable recipient may be, in one example, the source node receiving the second message as a reply to its message.

A message, although unlikely but possibly never finding its way to the destination node is nevertheless regarded as traveling along a path between a source node and a destination node, at least towards the destination node.

According to an embodiment, the device to obtain a semantic understanding of the part based on parsing the part.

According to an embodiment, the content comprises payload information and extension information associated with the payload information, wherein the device is to jointly parse at least a part of the payload information and at least a part of the extension information to obtain the parsing result.

According to an embodiment, the content comprises a payload information, wherein the device is to:
parse the payload information, wherein the parsing result is based on a meaning of the payload determined by the parsing, wherein the device is to determine the suitable recipient based on information indicating which node in the network is a designated sink for the payload information.

According to an embodiment, the device is to parse the part of the message to evaluate information in the second message indicating an experience of the first message along the path to determine the suitable recipient.

According to an embodiment, the first and/or the second message comprises extension information associated with payload information of the message, the extension information comprising an address field for indicating a recipient and/or sender of the message and/or comprising indicating one or more of a priority of the payload information, a number of allowed or requested repetitions, an acknowledgement class, an expiry information and a delivery time. Such a field like an address field may but is not required to be filled with information such as an address but may also remain empty, the emptiness providing for some sort of general information such as “unknown”, “arbitrary” and/or “not specified.

According to an embodiment, the content comprises a payload information and an extension information associated with the payload information, wherein the device is to:
parse the extension information, wherein the parsing result is based on a meaning of the extension determined by the parsing, wherein the device is to determine the suitable recipient based on information indicating which path through the network is in accordance with an overall goal of the first message.

According to an embodiment, the device is to determine that the device has access to information related to the path through the network and not contained in the extension and for including said information as at least one parameter into an extension information of the second message to increase the amount of information of the extension information of the second message when compared to the extension information of the first message.

According to an embodiment, the device is to determine the suitable recipient independent from a destination address of the destination node contained in the first message. For example, the address of the destination node may be available but remain unevaluated, e.g., it is ignored or otherwise considered and/or the address itself is not contained in the first message because an address field is empty or because the address field is not contained in the message.

According to an embodiment, the device is to obtain the parsing result to indicate a priority of the message, an alternative path through the network, a selection of the next node, and a timing request.

According to an embodiment, the device is to determine that a part of information contained in the payload information is available at a device along the path and/or is available at the destination node, e.g., using contextual information, wherein the device is to decrease an amount of information in the payload information of the second message when compared to an amount of information in the payload information of the first message by discarding the part of information to obtain a payload information of the second message.

According to an embodiment, the device is to modify information of the second message when compared to the first message, wherein modifying the information relates to at least one of:
restructuring information contained in the first message for the second message;
resort information contained in the first message for the second message;
change an amount of information of the first message for the second message; and
transcode at least a part of the first message for the second message.

For example, transcoding may relate to generate the message in a second format from a first format of the first message. Exemplary examples include to receive one or more TCP/IP packets or wireless signals and to transcode them into a satellite signal or an SMS of a mobile communication system or even a synthesized speech call of such a mobile communication network. The different requirements of the second format may be effectively considered by the device, e.g., knowing that a single SMS is possibly limited to a specific number of characters such that the device may, based on the parsing result, modify payload information to obtain at least a similar or even a same meaning not exceeding said number of characters, especially when preparing for a transmission opportunity related to a single SMS as described above.

According to an embodiment, the device is to change an amount of information of the second message when compared to the first message by:
adding at least one parameter to an extension information associated with a payload information of the first message;
removing at least one parameter from an extension information associated with a payload information of the first message;
compressing or reducing the amount of extension information associated with a payload information of the first message based on knowledge about redundancy information in the extension information and/or knowledge about available further context at another node along the path;
increasing the amount of extension information associated with a payload information of the first message based on redundancy information in the extension information;
adding a part to the payload information contained in the first message based on knowledge that the part of information is missing;
removing a part of the payload information contained in the first message based on knowledge that the part of information contained is available at a device along the path and/or is available at the destination node;
compressing or reducing the amount of payload information of the first message based on knowledge about redundancy information and/or knowledge about available further context at another node along the path;
increasing the amount of payload information of the first message based on redundancy information; and/or transcoding at least a part of a payload information associated with the extension information of the first message.

According to an embodiment, the device is to assess a level of completion of the extension information of the first message and to process further extension information.

According to an embodiment, the device is to modify a content of the first message to obtain the second message, e.g., to return the second message to the source node, based on a content of at least one message previously received by the device.

According to an embodiment, the second message is a reply to the first message directed to the source node.

According to an embodiment, the device is to determine, based on the parsing result, that the device is not the destination node but able to provide for at least a part of information and/or service requested with the first message and to provide the second message and/or a third message as a reply to the first message to provide the part.

According to an embodiment, the reply to the first message is a preliminary feedback that is to be returned to the source node in advance or as a substitute of the acknowledgment sent by the destination node.

According to an embodiment, the device is to include, into the preliminary feedback forwarding information related to a forwarding of a message from the source node to the device.

According to an embodiment, the device is to provide, towards the destination node, e.g., as a third message or as a part of the second message, status information indicating a status of the message and/or performed modifications of the message or the like

According to an embodiment, the device is to change an amount of information of the second message when compared to the first message by:
recording and/or updating, into the second message, information indicating an experience of the message along the path.

According to an embodiment, the device is to parse the part of the message to determine, a further course of the path according to one or more criteria.

According to an embodiment, the device is to derive, from the parsing result, that the first message is one of a set of interrelated messages, e.g., having a same destination node or group of destination nodes; wherein the device is to await reception of at least one further message of the set of interrelated messages; wherein the device is to generate at least the second message based on the first message and the at least one further message, e.g., by combining payload information of different messages and/or extension information of different messages for an aggregated message.

According to an embodiment, the device is to generate at least the second message and the third message based on the first message and the at least one further message; and to provide the second message and the third message to different nodes.

According to an embodiment, the device is to combine the payload information of the interrelated messages to obtain payload information of the second message. For example, two or messages, the interrelated messages, may be combined to obtain an aggregated payload, not excluding that such aggregated payload is further processed, e.g., to reduce redundancy or the like.

According to an embodiment, the device is to transcode at least a part of the payload information of the interrelated messages to obtain payload information of the second message.

According to an embodiment, the device is to generate, from the first message, at least the second message and a third message and to provide the second message and the third message towards a same node or towards different nodes, e.g., using same or different paths.

According to an embodiment, the device is to split up payload information and/or extension information associated with the payload information into a first part for the second message and a second part for the third message.

According to an embodiment, the first part and the second part comprise same information and/or structure or comprise different information and/or structure.

According to an embodiment, the device is to generate, based on the parsing result, from the first message different messages for different recipients, e.g., fire department, police department, military, e.g., based on different presets of the different recipients.

According to an embodiment, the device is to transcode at least the first message into at least the second message.

According to an embodiment, the device is to store information comprising at least one of:
a content of payload information of the first and/or second message;
a content of other packets that were forwarded; and
content derived or interpreted from external contextual information
   wherein the device is to generate the second message based on available stored information.

According to an embodiment, the device is to provide the second message using a different access technology, e.g., a radio access technology, RAT, when compared to receiving the first message.

According to an independent embodiment, a device for operating in a network to provide a forwarding functionality by providing a second message responsive to a received first message along a path between a source node and a destination node is provided. The device is to: receive the first message; parse a content [extension, payload] of the message to obtain a parsing result; change or modify an amount of information of the second information when compared to the first message by:
adding at least one parameter to an extension information associated with a payload information of the first message; and/or
removing at least one parameter from an extension information associated with a payload information of the first message;
adding a part to the payload information contained in the first message based on knowledge that the part of information is missing;
removing a part of the payload information contained in the first message based on knowledge that the part of information contained is available at a device along the path and/or is available at the destination node; and/or transcoding at least a part of a payload information associated with the extension information of the first message;

The device is to providing the second message.

According to an embodiment, a communication network comprises a plurality of devices according to one of previous embodiments of the third aspect.

According to an embodiment, the communication network comprises a plurality of access technologies or network types connecting the plurality of devices. That is, different links or regions of the overall network may be operated using different RATs, such as Wi-Fi, a mobile communication network, Bluetooth®, a satellite network and/or others.

According to an embodiment, the network is to route user-plane related information and control-plane related information through different segments of the communication network as a respective first message, wherein at least one device of the plurality of devices is to modify the user-plane related information or the control-plane related information when transmitting the second message.

According to an embodiment, the communication network comprises at least one of a wired, an optical network, an electrical network used for electrical energy generation, transmission, distribution and/or storage of electrical energy.

According to an independent embodiment, a device for operating in a network that provides a forwarding functionality for a message along a path or path segment between the device as a source node of the message and a destination node is provided, wherein the device is to receive a message as a preliminary feedback from an intermediate device contributing to the forwarding functionality, the preliminary feedback comprising forwarding information related to the forwarding of the message to the intermediate node; and/or wherein the device is to receive a first acknowledgment message acknowledging reception of the message and to transmit a second acknowledgement acknowledging reception of the first acknowledgment.

According to an embodiment, the device is to evaluate the preliminary feedback to obtain an evaluation result and to adapt a transmission strategy for future messages sent by the device based on the evaluation result.

According to an embodiment, the device is to transmit a message to acknowledge reception of the preliminary feedback.

According to an independent embodiment, a device for operating in a network that provides a forwarding functionality for a message along a path or path segment between a source node of the message and the device as a destination node is provided, wherein the device is to acknowledge reception of the message by transmitting a first acknowledgment message and to request to receive a second acknowledgement acknowledging reception of the first acknowledgment at the source node.

According to an independent embodiment, a method for operating a device in a network that provides a forwarding functionality along a path or path segment between a source node and a destination node, the device contributing to the forwarding functionality by providing a second message responsive to a received first message is provided, the method comprising:
receiving the first message;
parsing at least a part of the message to obtain a parsing result;
determining, based on the parsing result, a suitable recipient for the second message or a message derived thereof; and
providing the second message towards the suitable recipient.

According to an independent embodiment, a method for operating a device in a network to provide a forwarding functionality by providing a second message responsive to a received first message along a path between a source node and a destination node, is provided wherein the method comprises:
receiving the first message;
parsing a content of the message to obtain a parsing result;
changing or modifying an amount of information of the second information when compared to the first message by:
   adding at least one parameter to an extension information associated with a payload information of the first message; and/or
   removing at least one parameter from an extension information associated with a payload information of the first message;
   adding a part to the payload information contained in the first message based on knowledge that the part of information is missing;
   removing a part of the payload information contained in the first message based on knowledge that the part of information contained is available at a device along the path and/or is available at the destination node; and/or transcoding at least a part of a payload information associated with the extension information of the first message;

The device is to providing the second message.

According to an independent embodiment, a method for operating a device in a network that provides a forwarding functionality for a message along a path or path segment between the device as a source node of the message and a destination node is provided, the method comprising:
receiving a message as a preliminary feedback from an intermediate device contributing to the forwarding functionality, the preliminary feedback comprising forwarding information related to the forwarding of the message to the intermediate node; and/or
receiving a first acknowledgment message acknowledging reception of the message and to transmit a second acknowledgement acknowledging reception of the first acknowledgment.

According to an independent embodiment, a method for operating a device in a network that provides a forwarding functionality for a message along a path or path segment between a source node of the message and the device as a destination node, is provided the method comprising:
acknowledging reception of the message by transmitting a first acknowledgment message and requesting to receive a second acknowledgement acknowledging reception of the first acknowledgment at the source node.

Embodiments according to the third aspect may be combined with embodiments according to the first aspect and/or the second aspect without any limitations. A preparation of a reception and/or a transmission according to the first aspect may benefit from a message transport according to the third aspect, e.g., any available communication opportunity may be suitable for receiving and/or transmitting a message in view of the high flexibility of the network to forward messages and/or information thereof. Vice-versa, each of a source node, a destination node and a forwarding node may benefit from preparation according to a communication opportunity being known a priori.

Alternatively or in addition, a group-assisted communication according to the second aspect may benefit from a message forwarding mechanism according to the third aspect as the parsing allows different messages to be received and forwarded in the network whilst still ensuring that the suitable recipient will receive the message and/or that a reply will be received, e.g., from the recipient and/or tan intermediate node. Vice-versa, each of a group member source node, a destination node and a forwarding node may benefit from a group assistance.

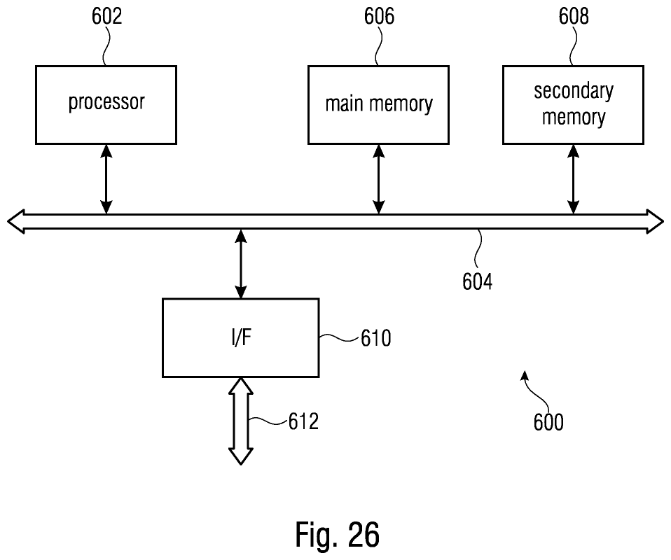

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 26 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

| Abbrevi- | | Further |
|---|---|---|
| ation | Definition | description |
| 2G | second generation | |
| 3G | third generation | |
| 3GPP | third generation partnership project | |
| 3PC | third-party controller | |
| 4G | fourth generation | |
| 5G | fifth generation | |
| 5GC | 5G core network | |
| AAS | active antenna system | |
| AAU | advanced antenna unit | |
| ACLR | adjacent channel leakage ratio | |
| ADC | analogue-to-digital converter | |
| AF | application function | |
| AP | access point | |
| ARQ | automatic repeat request | |
| AU | antenna unit | |
| BER | bit-error rate | |
| BLER | block-error rate | |
| BP | behaviour plane | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received signal | |
| CP | control plane | |
| CP1 | control plane 1 | |
| CP2 | control plane 2 | |
| CPRI | common public radio interface | |
| CSI-IM | channel state information interference | |
| | measurement | |
| CSI-RS | channel state information reference | |
| | signal | |
| CU | central/centralized unit | |
| D2D | device-to-device | |
| DAPS | dual active protocol stack | |
| DAC | digital-to-analogue converter | |
| DC-CA | dual-connectivity carrier aggregation | |
| DECT | digitally enhanced cordless telephony | |
| DL | downlink | |
| DMRS | demodulation reference signal | |
| DOA | direction of arrival | |
| DRB | data radio bearer | |
| DT | digital twin | |
| DU | distributed unit | |
| ECGI | e-UTRAN cell global identifier | |
| E-CID | enhanced cell ID | |
| eCall | emergency call | |
| eCPRI | enhanced CPRI | |
| eNB | evolved Node b | |
| EN-DC | e-UTRAN-New Radio dual connectivity | |
| EUTRA | enhanced UTRA | |
| E-UTRAN | enhanced UTRA network | |
| FSS | frequency-selective surface | |
| gNB | next generation NodeB | |
| GNSS | global navigation satellite system | |
| GPS | global positioning system | |
| GSO | geostationary orbit | |
| HAPS | high-altitude platforms | |
| HARQ | hybrid ARQ | |
| IAB | integrated access and backhaul | |
| ID | identity/identification | |
| IF | intermediate frequency | |
| IIOT | industrial internet of things | |
| KPI | key-performance indicator | |
| LEO | low Earth-orbit | associated with |
| | | satellites |
| LTE | long-term evolution | |
| MCG | master cell group | |
| MCS | modulation coding scheme | |
| MDT | minimization of drive tests | |
| MIMO | multiple-input/multiple-output | |
| MLR | measure, log and report | |
| MLRD | MLR device | |
| MNO | mobile network operator | |
| MR-DC | multi-rat dual connectivity | |
| NCGI | new radio cell global identifier | |
| NEF | network exposure function | |
| NG | next generation | |
| ng-eNB | next generation eNB | node providing |
| | | E-UTRA user |
| NG-RAN | either a gNB or an NG-eNB | |
| NGSO | non-geostationary orbit | |
| NIC | network interface connection | |
| NR | new radio | |
| NR-U | NR unlicensed | NR operating |
| | | in unlicensed |
| NTN | non-terrestrial network | |
| OAM | operation and maintenance | |
| OEM | original equipment manufacturer | |
| OoC/OOC | out-of-coverage | |
| OTT | over-the-top | |
| oRAN | see open RAN | |
| Open RAN | open radio access network | |
| PCI | physical cell identifier | Also known as |
| | | PCID |
| PDCP | packet data convergence protocol | |
| PER | packet error rate | |
| PHY | physical | |
| PLMN | public land mobile network | |
| QCL | quasi colocation | |
| RA | random access | |
| RACH | random access channel | |
| RAN | radio access network | |
| RAT | radio access technology | |
| RE | resource element | |
| RF | radio frequency | |
| RIM | radio access network information | |
| RIM-RS | rim reference signal | |
| RIS | reconfigurable intelligent surface | |
| RISC | RIS controller | |
| RLC | radio link control | |
| RLF | radio link failure | |
| RLM | radio link monitoring | |
| RP | reception point | |
| R-PLMN | registered public land mobile network | |
| RRC | radio resource control | |
| RRU | remote radio unit | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| RU | radio unit | |
| SA | standalone | |
| SCEF | service capability exposure function | |
| SCG | secondary cell group | |
| SDU | service data unit | |
| SIB | system information block | |
| SINR | signal-to-interference-plus-noise ratio | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SRI | sounding reference indication | |
| SS | synchronization signal | |
| SSB | synchronization signal block | |
| SSID | service set identifier | |
| SS-PBCH | sounding signal/physical broadcast | |
| TAC | tracking area code | |
| TB | transmission block | |
| TCI | transmission configuration indication | |
| TDD | time division duplex | |
| TN | terrestrial network | |
| TSG | technical specification group | |
| UAV | unmanned airborne vehicle | |
| UE | user equipment | |
| UL | uplink | |
| UP | user plane | |
| URLLC | ultra-reliable low latency communication | |
| UTRAN | universal trunked radio access network | |
| V2X | vehicle-to-everything | |
| VoIP | voice over internet protocol | |
| vRAN | virtual ran | |
| WI | work item | |
| Wi-Fi | a family of wireless network protocols | |
| | based on the IEEE 802.11 family of | |
| | standards | |
| WLAN | wireless local area network | |

1. A device comprising:
a wireless interface configured for processing a wireless signal;
wherein the device is to schedule the processing of the wireless signal to the occurrence of a communication opportunity being known in advance.

2. The device of claim 1, wherein the communication opportunity comprises a transmission opportunity, wherein the device is to generate a message to be transmitted with the wireless signal, and for scheduling a transmission of the wireless signal to the occurrence of the transmission opportunity.

3. The device of claim 2, wherein the device is to use, as communication opportunities, transmission opportunities and reception opportunities allowing for a bidirectional communication, wherein the device is to prepare for a reception during the reception opportunity.

4. The device of claim 3, wherein the reception opportunities are dynamic opportunities and/or wherein the transmission opportunities are continuous opportunities.

5. The device of claim 3, wherein the reception opportunity is located at a same or different instance in at least one of a time, a frequency, a radio access technology, RAT, and/or relates to a signal that is forwarded by another device, e.g., received as a broadcast and forwarded by a helper device.

6. The device of claim 2, wherein the device is to determine, based on the message to be transmitted, whether to pass the transmission opportunity, e.g., to wait for a subsequent transmission opportunity allowing feedback or the like, or to use the transmission opportunity to transmit the wireless signal, e.g., to use the first and optionally a second opportunity.

7. The device of claim 2, wherein the transmission of the wireless signal comprises at least one of:
distributing the wireless signal across at least two timeslots;
a repetition of the same wireless signal or parts thereof across at least two time slots; and
a distribution of multiple message parts which are encoded network coding across at least two timeslots.

8. The device of claim 2, wherein the device is to await a feedback associated with the wireless signal via a same or a different radio channel, radio access technology, RAT, and/or route through a wireless communication network in which the device communicates.

9. The device of claim 2, wherein the device is to generate the message to include information about a connectivity situation of the device.

10. The device of claim 2, wherein the device is to request information about a transmission opportunity or a reception opportunity wherein the opportunities are either granted or grant-free.

11. The device of claim 2, wherein the device is to select one of a plurality of transmission opportunities as a selected transmission opportunity to send the wireless signal based on a matching criterion indicating that the selected transmission opportunity matches a requirement of the wireless signal or of the message,

12. The device of claim 11, wherein the matching criterion relates to at least one of:
a time of transmitting or arriving of the message or of the wireless signal;
a frequency used for transmitting the wireless signal;
a size of the wireless signal and/or provided by the transmission opportunity;
a transmit power;
a transmit power spectral density;
a path loss to the opportunity;
a duration of the opportunity;
a dynamic of the opportunity;
a knowledge of a relationship between transmission and reception opportunities
a knowledge of an achievable throughput related to an opportunity

13. The device of claim 2, wherein the device is to request at least one additional communication opportunity, e.g., an additional transmission opportunity and/or a reception opportunity.

14. The device of claim 2, wherein the device is to enter a saving mode prior to the occurrence of the predefined transmission opportunity or a reception opportunity.

15. The device of claim 2, wherein the device is to prepare the transmission of the wireless signal and to wait for the occurrence of the transmission opportunity.

16. The device of claim 2, wherein the device is to operate in an operation mode and is unable to use a radio access technology for wireless transmission prior to the occurrence and to have an ability to use a radio access technology for the wireless transmission based on the occurrence.

17. The device of claim 2, wherein the device is to operate in an operation mode without connectivity to a radio access technology and for using a connectivity based on the occurrence.

18. The device of claim 2, wherein the device is to prepare the message in a language independent output being independent from a user language.

19. The device of claim 2, wherein the device is to provide a template to a user of the device, e.g., using a graphical interface, for receiving user input; and for preparing the message based on the user input.

20. The device of claim 2, wherein the device is to prepare the message at least in parts automated and based on an event, e.g., accelerometers, eCall in OoC, events, conditions, user input.

21. The device of claim 2, wherein the device is to transmit a signal to at least one other device, the signal comprising information about the transmission opportunity.

22. The device of claim 2, wherein the device is to receive and evaluate a signal from at least one other device, the signal comprising information about the transmission opportunity.

23. The device of claim 1, wherein the communication opportunity comprises a reception opportunity, wherein the device is to prepare for the reception during the reception opportunity.

24. The device of claim 23, wherein the device is to transmit a signal to at least one other device, the signal comprising information about the reception opportunity, e.g., to provide other devices with information allowing that the other devices may help receiving a signal.

25. The device of claim 23, wherein the device is to determine whether to let pass the reception opportunity, e.g., to wait for a subsequent opportunity allowing less errors in reception or the like, or to use the reception opportunity.

26. The device of claim 23, wherein the device is configured/enabled to select one of a plurality of reception opportunities as a selected reception opportunity to receive the wireless signal based on a matching criterion indicating that the selected reception opportunity matches a requirement of the wireless signal or of the message,

27. The device of claim 26, wherein the matching criterion relates to at least one of:
a time of transmitting or arriving of the message or of the wireless signal;
a frequency band used for receiving the wireless signal;
a size of the wireless signal and/or provided by the reception opportunity
a receive sensitivity;
a received interference power level;
a path loss to the opportunity;
a duration of the opportunity;
a dynamic of the opportunity;
a knowledge of a relationship between transmission and reception opportunities
a knowledge of an achievable throughput related to an opportunity

28. The device of claim 1, wherein the communication opportunity relates to at least one of:
performing the transmission as a blind transmission using pre-defined frequency resources at a specific time, e.g., as a international maritime distress call, using a terrestrial network, TN and/or a non-terrestrial network, NTN, resource;
performing, prior to the transmission, a sensing or listening for network opportunities;
performing, prior to the transmission, a sensing or listening for emergency beacons
performing, prior to the transmission, a sensing or listening for device-to-device (D2D) sidelink (SL) opportunities
transmitting to and/or receiving from a satellite;
receiving a signal directed to the device or a different device
acting upon or responding to a wake-up signal before transmitting
